(19) United States
(12) Patent Application Publication
(10) Pub. No.: US 2009/0168114 A1
(43) Pub. Date: Jul. 2, 2009

(54) Image Forming Apparatus And Image Forming System

(75) Inventor: Hironobu NISHIMURA, Fukushima-Shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 12/345,027

(22) Filed: Dec. 29, 2008

(30) Foreign Application Priority Data
Dec. 28, 2007 (JP) 2007-339672

(51) Int. Cl. H04N 1/00

(52) U.S. Cl. 358/402

(57) ABSTRACT

An image forming apparatus and an image forming system are supplied capable of obtaining a simple system structure without increasing traffic. In the system, an image forming apparatus is connected with a delivery source user terminal serving as a delivery source of print data, and with at least one delivery destination user terminal allowed to use the print data via network. In the apparatus, a store controlling section receives the print data to which user information representing the delivery destination user terminal is appended from the delivery source user terminal, and stores the print data into a print data storing section; a delivery destination notifying section performs a notification representing a print need/needlessness based on an existence of the print data and the print data, for the delivery destination user terminal represented in the user information; and a print need/needlessness judging section, when received a print request from the delivery destination user terminal, obtains the print data from the print data storing section and supplies the print data to a print processing section for executing a print of the print data.

### FIELD OF THE INVENTION

The invention relates to an image forming apparatus and an image forming system in which user terminal and image forming apparatus are connected via network.

### BACKGROUND OF THE INVENTION

With network is spread, now an electronic mail system is utilized. In the electronic mail system, a same document can be supplied to plural delivery destinations once. That is, if only to attach an image file or the like to an electronic mail and send the electronic mail to plural delivery destinations, the plural delivery destinations can refer to terminal scene of their own self, then to print the image file, therefore, delivery source can ease burden such as print and the like. But, in the case to send the electronic mail containing the attached file to the plural delivery destinations, because network line is repeatedly utilized for transferring the same data, the utilization amount (traffic) of the network line is increased, so that the transfer speed on the network line is lowered. Then, in the following Patent Document 1, an electronic mail system which is used to print electronic mail and can improve utilization efficiency of network line is proposed.

Patent Document 1: Japan patent publication 2003-067292.

In the electronic mail system, plural mail clients, mail server and image forming apparatus are connected with network, when the mail server received an electronic mail containing an attachment file to be sent to plural delivery destinations, the mail server stores the attachment file in the electronic mail into the image forming apparatus and deletes the attachment file from the electronic mail. Then, the mail server appends a mail address of the image forming apparatus storing the attachment file to the electronic mail and delivers the electronic mail to the plural delivery destinations. Thus, each delivery destination can request a print to the image forming apparatus having the mail address so as to print the attachment file. Therefore, according to such electronic mail system, because the electronic mail is sent to the plural delivery destinations after deleted the attachment file, the utilization amount (traffic) of the network line is decreased, so it is possible to prevent the transfer speed of data on the network line from being lowered.

However, in such electronic mail system, the mail server and the image forming apparatus need to keep many functions, further, because only some special companies or organizations can have the mail server, so it is limited to introduce such electronic mail system. Furthermore, in such electronic mail system, because complex control is needed between the image forming apparatus and the mail server, special software to correspond to the complex control is needed.

### SUMMARY OF THE INVENTION

It is, therefore, an object of the invention to provide an image forming apparatus and an image forming system capable of solving the above problem, that is, capable of easily printing electronic file without increasing traffic.

An aspect of the invention is to provide an image forming apparatus which is connected with a delivery source user terminal serving as a delivery source of print data, and with at least one delivery destination user terminal allowed to use the print data via network, comprising:

a store controlling section that receives the print data to which user information representing the delivery destination user terminal is appended from the delivery source user terminal, and stores the print data into a print data storing section;

a delivery destination notifying section that performs a notification representing a print need/needlessness based on an existence of the print data and the print data, via the network, with respect to the delivery destination user terminal represented in the user information; and

a print need/needlessness judging section that, when received a print request from the delivery destination user terminal via the network, obtains the print data from the print data storing section and supplies the print data to a print processing section for executing a print of the print data.

Another aspect of the invention is to provide an image forming system, in which image forming apparatus, a delivery source user terminal serving as a delivery source of print data, and at least one delivery destination user terminal allowed to use the print data are connected via network,

wherein the delivery source user terminal has a delivery destination notifying section that performs a notification representing that the print data exists in the image forming apparatus and print request is possible, via the network, with respect to the delivery destination user terminal, and

wherein the image forming apparatus includes:

a store controlling section that receives the print data to which user information representing the delivery destination user terminal is appended from the delivery source user terminal, and stores the print data into a print data storing section; and

a print need/needlessness judging section that, when received a print request from the delivery destination user terminal via the network, obtains the print data from the print data storing section and supplies the print data to a print processing section for executing a print of the print data.

### The Effect of the Present Invention:

According to the invention, in image forming system in which user terminal and image forming apparatus are connected via network, information indicating delivery destination and print data are stored in the image forming apparatus, and a notification is sent from the image forming apparatus to the delivery destination to notify that the print data exists and print execution is possible, thus, delivery source does not need to directly send print data to delivery destination. Therefore, traffic on network is not increased and mail server becomes unnecessary. So it is possible to supply an image forming system whose structure become simple and which can easily print electronic file.

The above and other objects and features of the present invention will become apparent from the following detailed description and the appended claims with reference to the accompanying drawings.

### BRIEF DESCRIPTION OF THE DRAWINGS

FIG. 1 is an explanatory diagram showing a structure of an image forming system in embodiment 1 of the present invention;

FIG. 2 is a diagram showing a structure of a user terminal in embodiment 1 of the present invention;

FIG. 3 is a diagram showing a structure of an image forming apparatus in embodiment 1 of the present invention;

FIG. 4A is an explanatory diagram for use setting information stored in an information memorizing section in embodiment 1;

FIG. 4B is an explanatory diagram for address information of image forming apparatus, stored in an information memorizing section in embodiment 1;

FIG. 5 is an explanatory diagram about flows of respective information between apparatuses in embodiment 1;

FIG. 6 is a flowchart for explaining operation of printer driver of user terminal in embodiment 1;

FIG. 7 is a flowchart for explaining operation about a print data process of image forming apparatus in embodiment 1;

FIG. 8 is a flowchart for explaining operation about a Web data process of image forming apparatus in embodiment 1;

FIG. 9 is a flowchart for explaining operation to store and manage print data in image forming apparatus in embodiment 1;

FIG. 10 is a flowchart for explaining operation about communication between image forming apparatuses in embodiment 1;

FIG. 11 is an explanatory diagram showing a mail display scene for mail delivered to user terminal in embodiment 1;

FIG. 12A is a first explanatory diagram showing state information of image forming apparatus, displayed on user terminal in embodiment 1;

FIG. 12B is a second explanatory diagram showing state information of image forming apparatus, displayed on user terminal in embodiment 1;

FIG. 12C is a third explanatory diagram showing state information of image forming apparatus, displayed on user terminal in embodiment 1;

FIG. 12D is a fourth explanatory diagram showing state information of image forming apparatus, displayed on user terminal in embodiment 1;

FIG. 13 is an explanatory diagram showing a mail display scene for mail delivered to user terminal form image forming apparatus in embodiment 2;

FIG. 14 is a flowchart for explaining operation about a Web data process of image forming apparatus in embodiment 2;

FIG. 15 is a flowchart for explaining operation to store and manage print data in image forming apparatus in embodiment 2;

FIG. 16 is an explanatory diagram about flows of respective information between apparatuses in embodiment 3;

FIG. 17 is a flowchart for explaining operation about a process of print request outputted form user terminal in embodiment 3;

FIG. 18 is a flowchart for explaining operation about mail delivery of image forming apparatus in embodiment 3;

FIG. 19 is a flowchart for explaining operation about communication between image forming apparatuses in embodiment 3;

FIG. 20 is a diagram showing a structure of a user terminal in embodiment 4 of the present invention;

FIG. 21 is an explanatory diagram showing a structure of an image forming system of the present invention in embodiment 4;

FIG. 22 is an explanatory diagram about flows of respective information between apparatuses in embodiment 4;

FIG. 23 is a flowchart for explaining operation of printer driver of user terminal in embodiment 4;

FIG. 24 is a flowchart for explaining operation about print data management application of user terminal in embodiment 4;

FIG. 25 is a flowchart for explaining operation about a receiving data process received from delivery source in embodiment 4; and

FIG. 26 is an explanatory diagram about flows of respective information between apparatuses in embodiment 5.

### DETAILED DESCRIPTION OF THE PREFERRED EMBODIMENTS

Embodiments of the invention will be described in detail hereinbelow with reference to the drawings.

### Embodiment 1

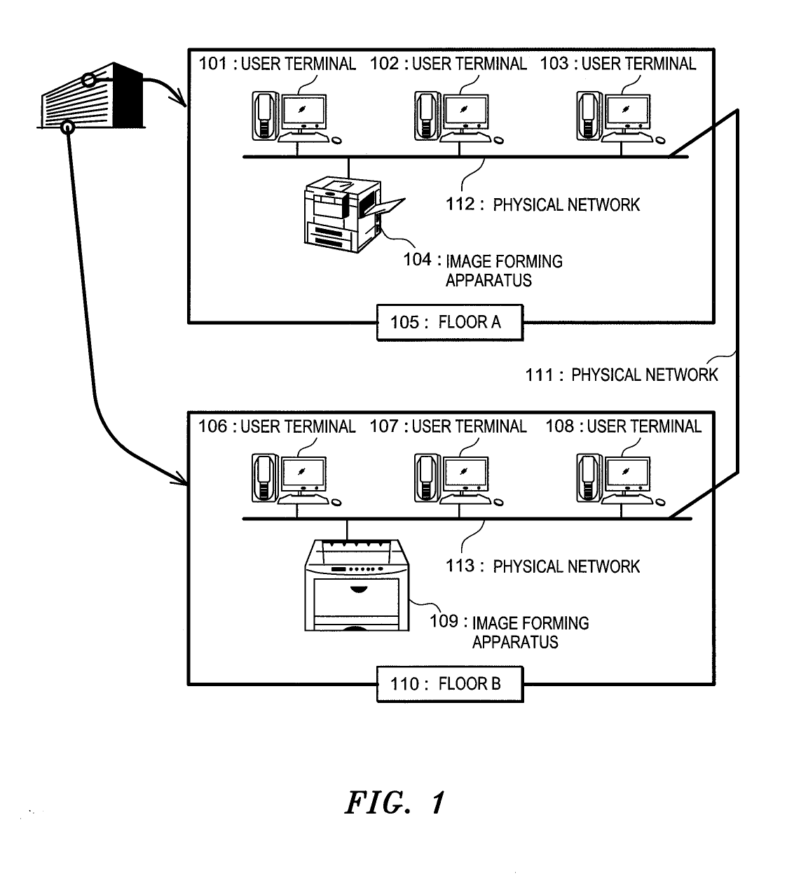

FIG. 1 is an explanatory diagram showing a structure of an image forming system in embodiment 1 of the present invention.

As shown by FIG. 1, in an image forming system of the present invention, an image forming apparatus 104, a user terminal 101, a user terminal 102, and a user terminal 103 are connected via a network 112 on floor A 105 of a building; an image forming apparatus 109, a user terminal 106, a user terminal 107, and a user terminal 108 are connected via a network 112 on floor A 110 of a building; and the network 112 and the network 113 are connected by a network 111. The network 111, the network 112 and the network 113 are, for example, LAN in company; the user terminals and the image forming apparatuses have respective mail addresses and respective IP addresses.

The image forming apparatus which can be used by user terminal is previously set. For example, the image forming apparatus 104 put on the floor A 105 is set to be used by the user terminal 101, the user terminal 102 and the user terminal 103; and the image forming apparatus 109 put on the floor A 110 is set to be used by the user terminal 106 the user terminal 107 and the user terminal 108.

The user terminal 101 (delivery source) has print data which is possible to be used by the user terminals 102, 103, 106, 107 and 108 that serve as delivery destinations.

Next, it is to explain structures of respective components. First is to explain user terminal.

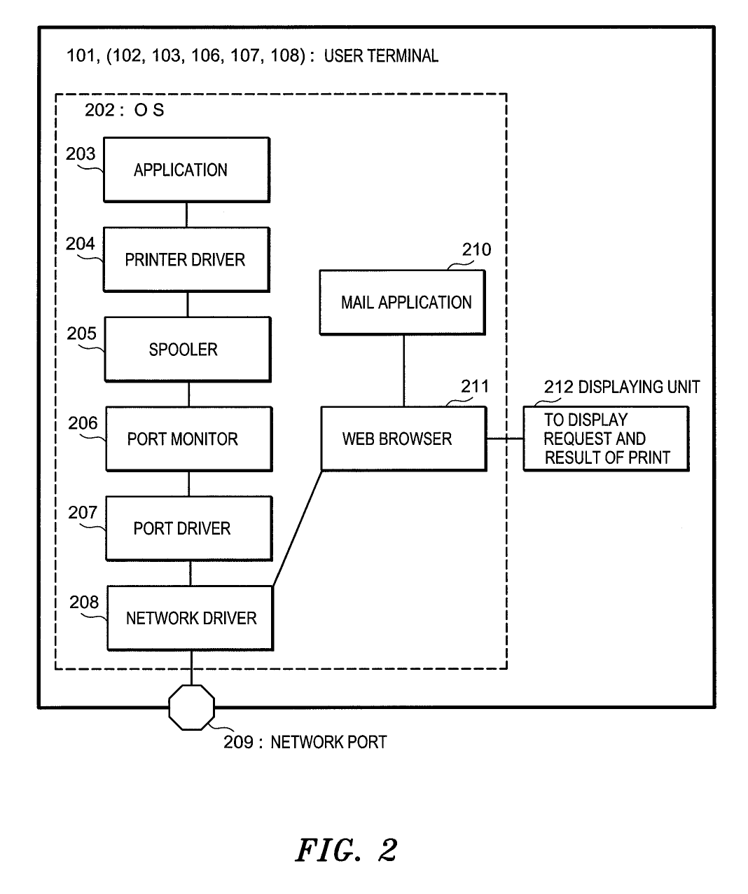

FIG. 2 is a diagram showing a structure of a user terminal in embodiment 1 of the present invention.

As shown by FIG. 2, the user terminal 101 has a displaying unit 212 and a network port 209 that serve as hardware elements; and OS, various applications and drivers that serve as software elements.

The OS 202 is basic software to supply basic function for operating the user terminal 101. In the applications installed in the user terminal 101, common operations to open file, to display scene and the like exist. The OS 202 supply process of common part such as the common operations to the respective applications.

Under environment of the OS 202, as shown by FIG. 2, an application 203, a printer driver 204, a spooler 205, a port monitor 206, a port driver 207, a network driver 208, a Web browser 211, and a mail application 210 operate.

The application 203 is a general-purpose application to operate on the OS 202. For example, it may be document making software, graphics making software, list calculation software, database software, or the like.

The printer driver 204 is software which operates on the OS 202, and performs a process to change the print data generated by the application 203 to print data which can be processed by image forming apparatus. Further, in the case to make the print data be printed at plural delivery destinations, the printer driver 204 generates a print data store request for storing the print data into image forming apparatus, and generates user information composed of information indicating the plural delivery destinations.

The spooler 205 is software which operates on the OS 202, and is used for sending print data and the like supplied from the printer driver 204 to image forming apparatus while using the application 203.

The port monitor 206 is software which operates on the OS 202, and performs to monitor the network port 209 used to communicate with image forming apparatus.

The port driver 207 is software which operates on the OS 202, and performs a connection control of the network port 209 used for connecting to image forming apparatus.

The network driver 208 is software which operates on the OS 202, and performs protocol and physical communication control of the network port 209 for connecting to image forming apparatus.

The network port 209 is an interface part for connecting to image forming apparatus.

The mail application 210 is a general-purpose application to operate on the OS 202.

The Web browser 211 is a browser application to perform a general-purpose Web data process operating on the OS 202. For example, it may be internet explorer or the like.

The displaying unit 212 is a displaying unit to perform display of character, figure or the like according to instruction of the OS 202 connecting with the user terminal 101 and instruction of application operating on the OS 202.

Moreover, as delivery destination, the user terminal 102, the user terminal 103, the image forming apparatus 104, the user terminal 106, the user terminal 107 and the user terminal 108 have the same structure as the user terminal 101.

Continuously, it is to explain the image forming apparatus 104.

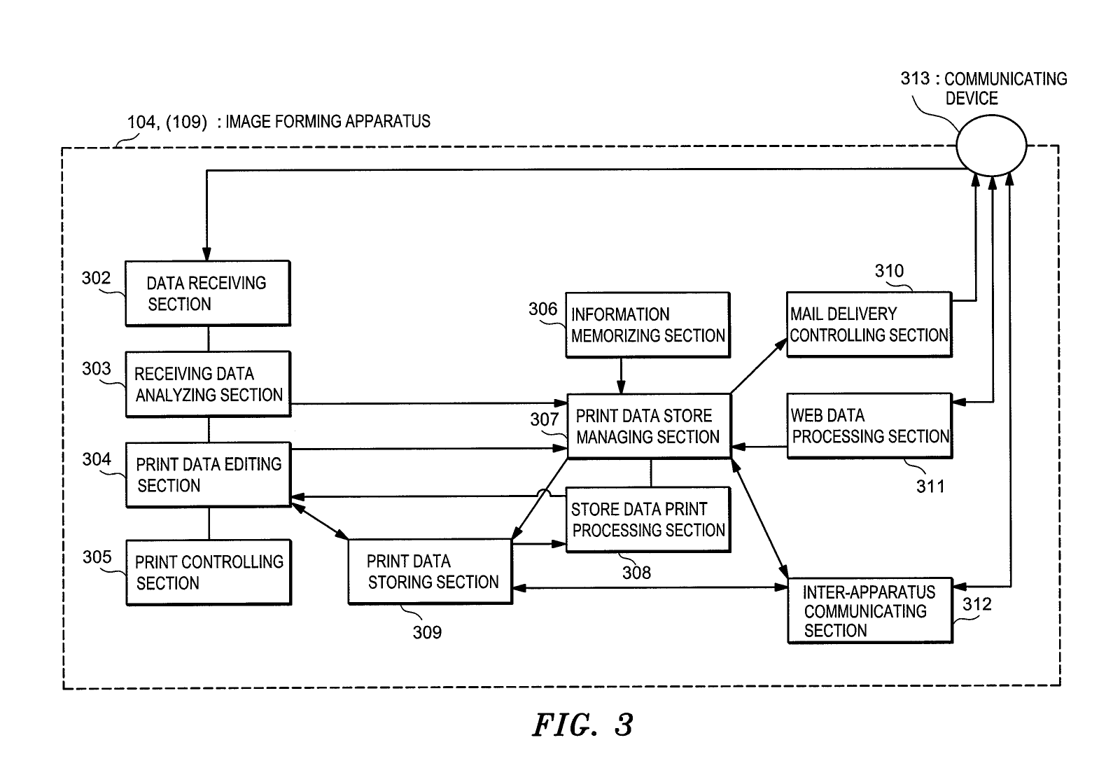

FIG. 3 is a diagram showing a structure of an image forming apparatus in embodiment 1 of the present invention.

As shown by FIG. 3, the image forming apparatus 104 includes a data receiving section 302, a receiving data analyzing section 303, a print data editing section 304, a print controlling section 305, an information memorizing section 306, a print data store managing section 307, a store data print processing section 308, a print data storing section 309, a mail delivery controlling section 310, a Web data processing section 311, an inter-apparatus communicating section 312, and a communicating device 313.

The data receiving section 302 is part to receive data sent from the user terminal 101.

The receiving data analyzing section 303 is a part to analyze receiving data supplied from the data receiving section 302. On the one hand, if the receiving data only is print data, the receiving data analyzing section 303 immediately supplies the print data to the print data editing section 304. On the other hand, if the receiving data containing user information and store request that are appended to the print data, the receiving data analyzing section 303 supplies the user information to the print data store managing section 307 so as to manage print data. The receiving data analyzing section 303 supplies the user information and the print data to the print data editing section 304.

The print data editing section 304 is a part to change the print data supplied from the receiving data analyzing section 303 into printable data, and supplies the printable data to the print controlling section 305. Further, the print data editing section 304, in the case that the user information and the print data are supplied, store the user information and the print data into the print data storing section 309.

The print data storing section 309 is a physical storing device such as HDD (Hard Disk Drive), flash memory or the like furnished in image forming apparatus.

The print data editing section 304, after the user information and the print data have been stored, notifies the print data store managing section 307 that store is completed; generates information representing store location of the user information and the print data in the print data storing section 309; and supplies the information representing store location to the print data store managing section 307.

The print controlling section 305 is a part to print the print data that has been changed into printable form by the print data editing section 304.

In the information memorizing section 306, use setting information in which user terminal and image forming apparatus are corresponding to and IP address of each image forming apparatus are stored.

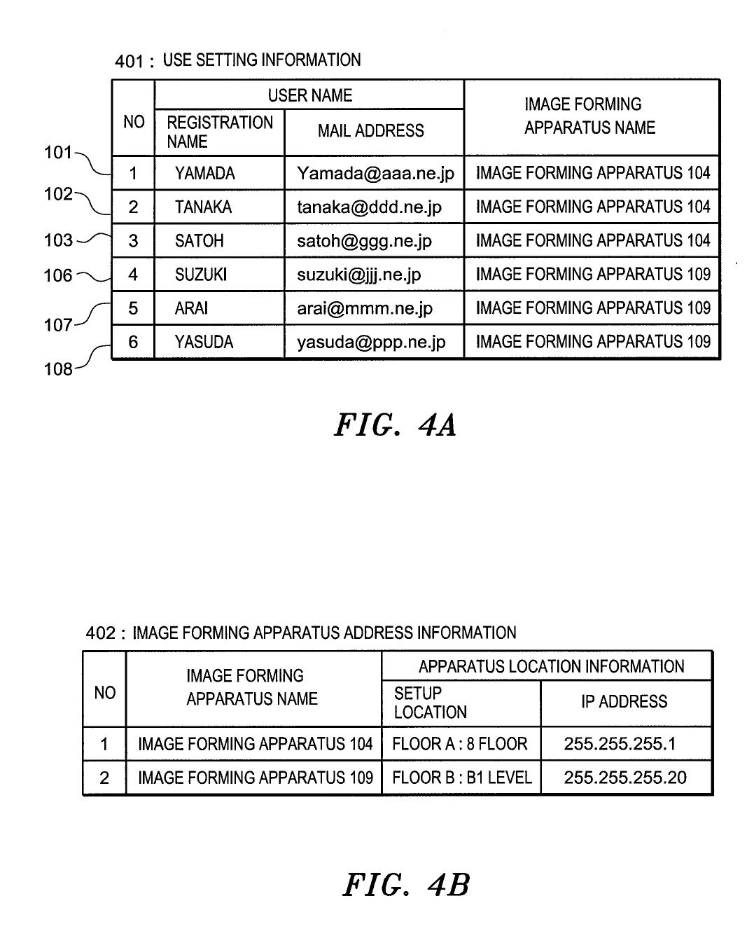

FIG. 4A is an explanatory diagram for use setting information stored in an information memorizing section in embodiment 1; and FIG. 4B is an explanatory diagram for address information of image forming apparatus, stored in an information memorizing section in embodiment 1.

As shown by FIG. 4A, use setting information 401 contains registration name of user, mail address, image forming apparatus name used and set by user. As shown by FIG. 4B, image forming apparatus address information 402 contains image forming apparatus name, setup location and IP address. Moreover, a means to register the use setting information 401 and the image forming apparatus address information 402 into image forming apparatus is a general existing technology, so its explanation is omitted.

It is to continue explanation of FIG. 3. The print data store managing section 307 is a part to manage the user information and the print data in which store request is appended. The print data store managing section 307, after received a management request of the user information and the print data from the receiving data analyzing section 303, waits for a store completion notification of the user information and the print data, that will be outputted from the print data editing section 304. The print data store managing section 307, after received the notification, receives the information representing store location of the user information and the print data in the print data storing section 309, that is generated by the print data editing section 304; and keeps the information. Then, the print data store managing section 307 refers to the use setting information shown by FIG. 4A; if a user terminal which is not set to use the image forming apparatus 104 of its own self exists in user terminals described in the user information, refers to the IP address shown by FIG. 4B to transfer user information of delivery source and print data to the image forming apparatus 109 which is set to be used by the user terminal, via the inter-apparatus communicating section 312. The print data store managing section 307, after the print data is stored and is transferred, notifies the mail delivery controlling section 310 of a store completion of print data.

The mail delivery controlling section 310 is a part to generate mail describing URL indicating IP address representing its own image forming apparatus in which print data is stored for print execution; and delivers the mail to respective user terminals described in user information in the instruction of the print data store managing section 307.

Next, it is to explain the mail.

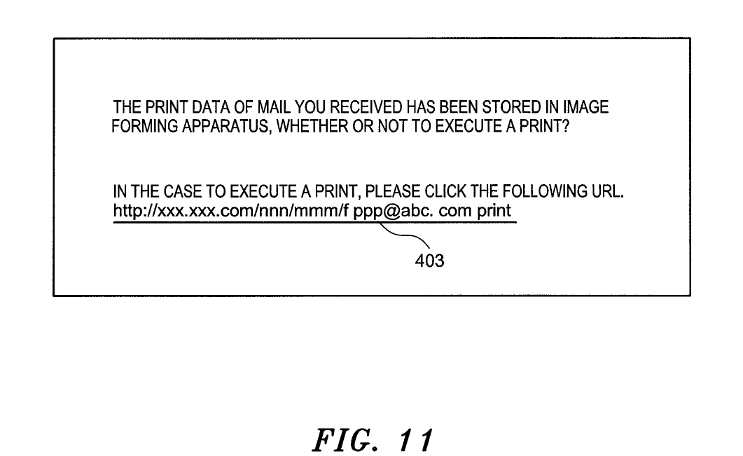

FIG. 11 is an explanatory diagram showing a mail display scene for mail delivered to user terminal in embodiment 1.

As shown by FIG. 11, the mail contains a content of notifying that image forming apparatus has stored print data, and a content of inquiring whether or not to execute print. On the underside of a scene displaying the mail, a URL 403 is described for executing print.

It is to continue the explanation about FIG. 3. The print data store managing section 307, after received request such as print execution and the like from the user terminal 102 and the user terminal 103 that serve as mail delivery destination via the Web data processing section 311, notifies the store data print processing section 308 of store information of print data storing section 309 to correspond to user terminal.

The store data print processing section 308 uses the store information to obtain print data corresponding to user terminal from the print data storing section 309; and supplies the print data to the print data editing section 304.

The inter-apparatus communicating section 312 is a part to send print data and user information to another image forming apparatus 109 according to an instruction of the print data store managing section 307 as stated above. Further, the inter-apparatus communicating section 312 notifies the print data store managing section 307 of the print data and user information transferred from the image forming apparatus 109.

The communicating device 313 is an interface part to connect to other apparatus by line.

Next, it is to explain a summary that user terminals 102˜103 and 106˜108 execute a print of print data belonging to the user terminal 101 in FIG. 1.

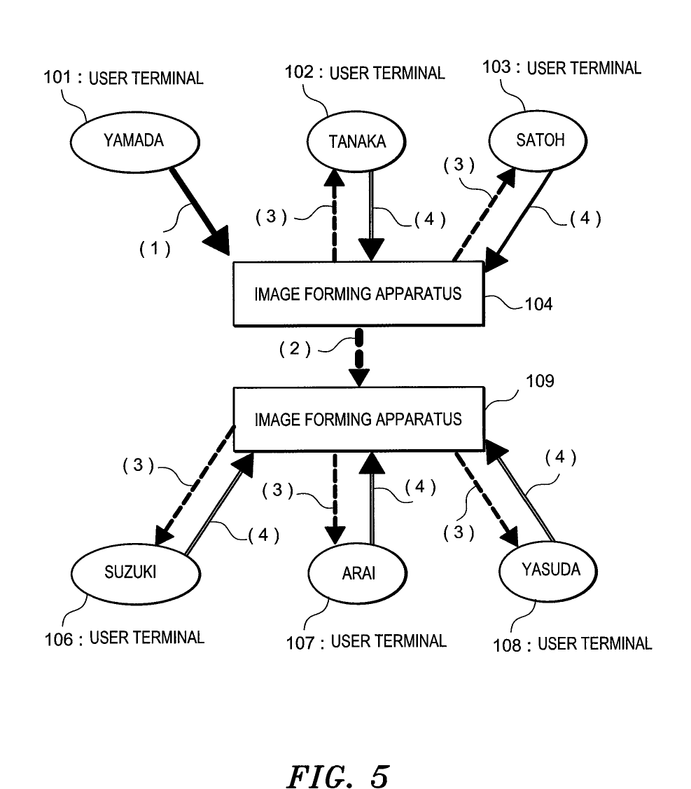

FIG. 5 is an explanatory diagram about flows of respective information between apparatuses in embodiment 1.

The respective information includes print data, store request, user information, print request and the like. The following is to explain flows of the respective information.

Flow (1) of information:

The user terminal 101 (delivery source) regards the user terminals 102˜103 and 106˜108 as delivery destination to send user information and print data in which store request is appended to the image forming apparatus 104.

Flow (2) of information:

The image forming apparatus 104 stores the print data and verifies the user information on the basis of information shown by FIG. 4. If it is verified that the user terminals 106˜108 that are set to use the image forming apparatus 109 are contained in the user information, the image forming apparatus 104 sends the user information and the print data to the image forming apparatus 109 moreover, the user information sent to the image forming apparatus 109 from the image forming apparatus 104 only represents the user terminals 106˜108.

Flow (3) of information:

The image forming apparatus 104 sends a mail describing a URL for executing print to the user terminals 102˜103. Likewise, the image forming apparatus 109 also sends a mail describing a URL for executing print to the user terminals 106˜108.

Flow (4) of information:

The user terminals 102˜103 and 106˜108 start Web browser to send an instruction for executing print to image forming apparatuses according to the received mail. That is, the user terminals 102˜103 send an instruction for executing print to the image forming apparatus 104; and the user terminals 106˜108 send an instruction for executing print to the image forming apparatus 109. The image forming apparatus 104 and the image forming apparatus 109 respectively start a print to correspond to the instruction for executing print.

Next, it is to explain operations of respective sections in each image forming apparatus of embodiment 1 according to flowchart.

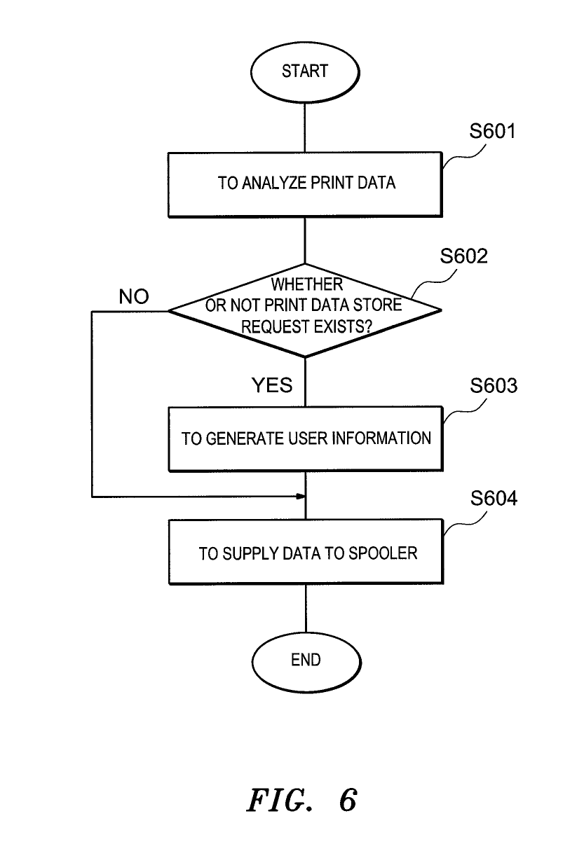

FIG. 6 is a flowchart for explaining operation of printer driver of user terminal in embodiment 1.

The following is to perform an explanation according to an order from step S601 to step S604 in the flowchart of FIG. 6, together with FIG. 2.

Step S601:

The printer driver 204 analyzes print data generated by application 203.

Step S602:

The printer driver 204 judges whether or not a store request is appended to the print data. If a store request is appended to the print data, step S603 is executed; if a store request is not appended to the print data, step S604 is executed.

Step S603:

The printer driver 204 generates user information representing the user terminals 102˜103 and 106˜108, through user of delivery source inputs instruction to users of delivery destination

Step S604:

In the case that a store request is not appended to the print data, the printer driver 204 changes the print data into printable print data and sends it to the spooler 205. In the case that a store request is appended to the print data, the printer driver 204 first supplies the store request and the generated user information to the spooler 205, second changes the print data into printable print data and sends it to the spooler 205.

Then, the image forming apparatus 104, after received the user information representing the user terminals 102˜103 and 106˜108 and the print data in which store request is appended from the user terminal 101 serving as delivery source, store the print data for enabling the user terminals 102˜103 to instruct a print; further sends the print data to the other image forming apparatus 109.

Continuously, it is to explain the image forming apparatus 104 which has received the user information representing the user terminals 102˜103 and 106˜108 and the print data in which store request is appended.

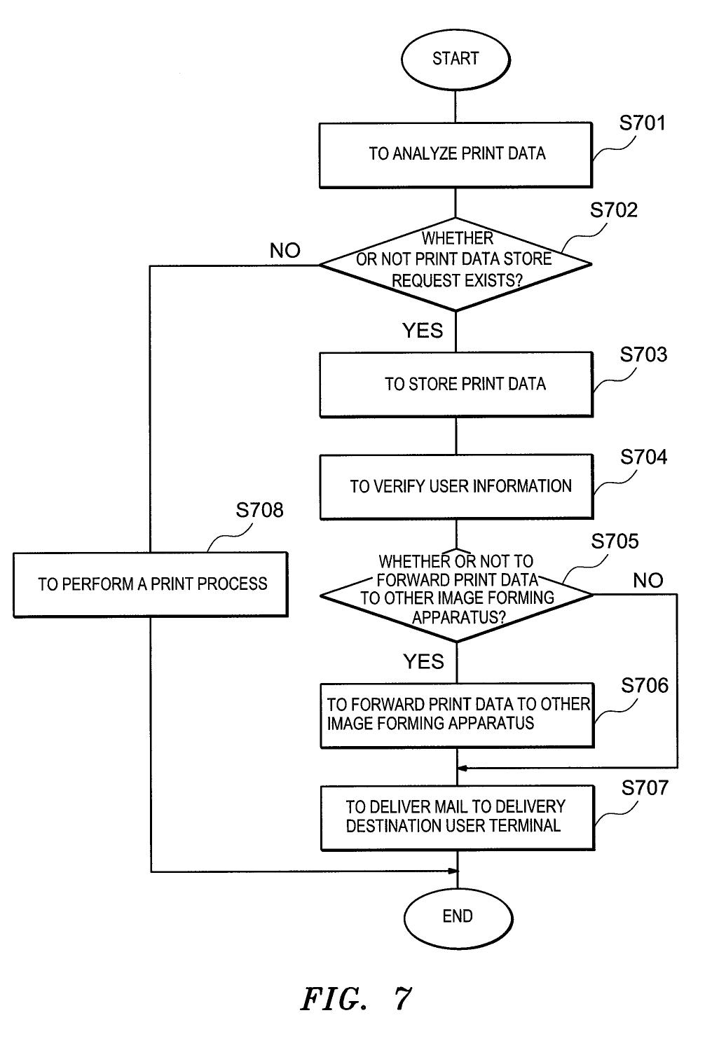

FIG. 7 is a flowchart for explaining operation about a print data process of image forming apparatus in embodiment 1.

The following is to perform an explanation according to an order from step S701 to step S708 in the flowchart of FIG. 7, together with FIG. 3.

Step S701:

The data receiving section 302 of the image forming apparatus 104, after received the print data, supplies the print data to the receiving data analyzing section 303 for analysis.

Step S702:

The receiving data analyzing section 303 judges whether or not user information representing the user terminals 102˜103 and 106˜108 and a store request are appended to the print data. If user information representing the user terminals 102˜103 and 106˜108 and a store request are appended to the print data, step S703 is executed; if they are not appended to the print data, step S708 is executed.

Step S703:

The receiving data analyzing section 303 supplies the user information to the print data store managing section 307. Then, the receiving data analyzing section 303 supplies the print data to the print data editing section 304 in order to store the user information and the print data. The print data editing section 304 stores the user information and the print data into the print data storing section 309. The print data editing section 304, after the store is completed, notifies the print data store managing section 307 of a completion of store.

Step S704:

The print data store managing section 307 detects whether or not use setting person set to use other apparatus except the image forming apparatus 104 exists, according to the use setting information shown by FIG. 4A in the information memorizing section 306 from the supplied user information.

Step S705:

If the user terminals 106˜108 serve as the use setting persons to use the image forming apparatus 109 and exist in the supplied user information, step S706 is executed; if any of they does not exist, step S707 is executed.

Step S706:

The print data store managing section 307 refers to the use setting information shown by FIG. 4A to judge that the user terminals 106˜108 that are not set to use the image forming apparatus 104 of its own self exist in the user terminals described in the user information, therefore, further refers to the IP address shown by FIG. 4B in the information memorizing section 306 to confirm an address of the image forming apparatus 109. The print data store managing section 307 transfers the print data and information representing delivery destination user to the image forming apparatus 109 which is set to be used by the user terminals 106˜108, via the inter-apparatus communicating section 312.

Step S707:

The print data store managing section 307, after received information representing store location in the print data storing section 309 about the print data and the user information that are generated by the print data editing section 304, from the print data editing section 304, supplies the information to the mail delivery controlling section 310 together with user information (user terminals 102, 103). The mail delivery controlling section 310 delivers a mail describing information representing store location of print data and URL representing a print execution to the user terminals 102, 103 described in the user information.

Step S708:

The print data editing section 304, in the case that there is nothing to be appended to the print data, changes the print data into printable print data and supplies it to the print controlling section 305. The print controlling section 305 executes a print.

Moreover, though it is not explained in the flowchart, the image forming apparatus 109 to which the information representing delivery source user and the print data are transferred, like the image forming apparatus 104, also delivers a mail describing information representing store location of print data and URL representing a print execution to the user terminals 106˜108 on the basis of the user information of delivery destination.

Continuously, it is to explain the Web data processing section 311 of the image forming apparatus 104 of embodiment 1.

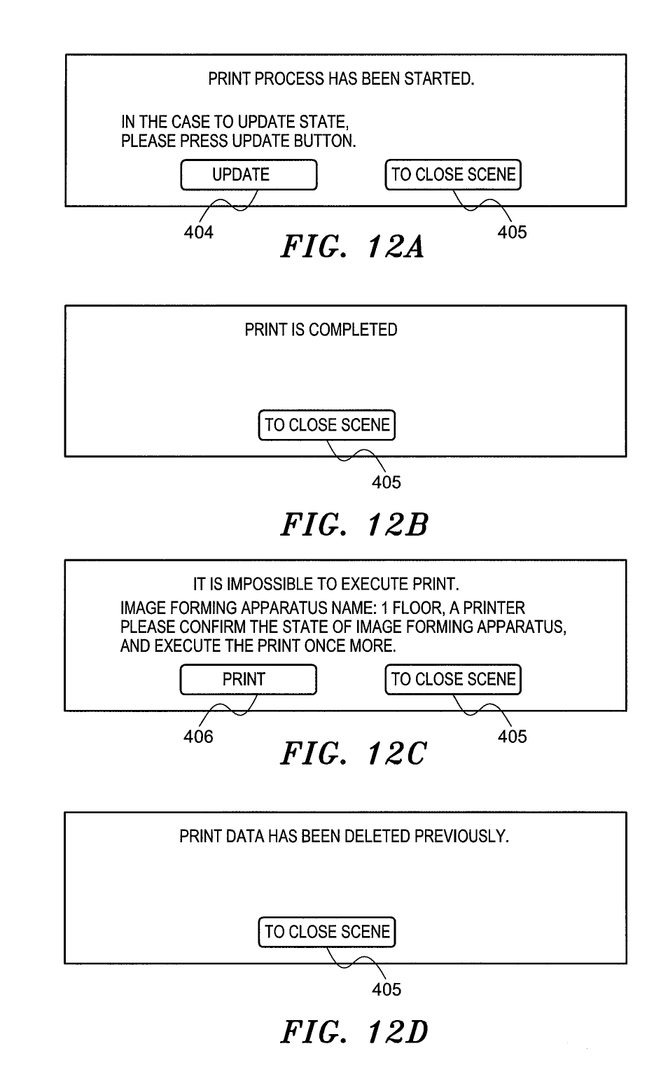

FIG. 12A is a first explanatory diagram showing state information of image forming apparatus, displayed on user terminal in embodiment 1; FIG. 12B is a second explanatory diagram showing state information of image forming apparatus, displayed on user terminal in embodiment 1; FIG. 12C is a third explanatory diagram showing state information of image forming apparatus, displayed on user terminal in embodiment 1; and FIG. 12D is a fourth explanatory diagram showing state information of image forming apparatus, displayed on user terminal in embodiment 1.

The FIG. 12A shows a Web browser scene displayed on the user terminal 102 (and user terminal 103) when clicking the URL 403 shown by FIG. 11. In the scene, a message to notify that a print has been started; an “Update” icon 404 for requesting print process situation of image forming apparatus; a “To close scene” icon 405 for closing the Web browser scene by user, are displayed.

The FIG. 12B shows a Web browser scene after user pressed the “update” icon 404 shown by FIG. 12A. In the scene, a message to notify that the image forming apparatus 104 has completed print; and a “To close scene” icon 405 for closing the Web browser scene by user, are displayed.

The FIG. 12C shows a Web browser scene after user pressed the “update” icon 404 shown by FIG. 12A. In the scene, a message to notify that the image forming apparatus 104 cannot execute print such as “it is impossible to execute print. Please confirm eh state of image forming apparatus”; a “Print” icon 406 for re-executing a print; a “To close scene” icon 405 for closing the Web browser scene by user, are displayed.

The FIG. 12D shows a Web browser scene displayed on the user terminal 102 (and user terminal 103) when clicking the URL 403 shown by FIG. 11. In the scene, a message to notify that the deadline of print data has passed previously so that print data has been deleted; and a “To close scene” icon 405 for closing the Web browser scene by user, are displayed.

In the image forming apparatus 104, after the store of print data is completed and the print data has been transferred to the image forming apparatus 109, the mail delivery controlling section 310 delivers mail describing store location of stored print data and describing the URL representing a print execution, to the user terminals 102, 103 of delivery destination. Through driving the Web browser 211 to click the URL representing a print execution in respective user terminals, the Web data processing section 311 of the image forming apparatus 104 receives Web data representing a print instruction.

The image forming apparatus 104, after received a print execution from the user terminal, sends state information to the user terminal via the Web data processing section 311. In the state information, there are “print start”, “print completion”, “print failure”, “data deletion” and the like, as stated the explanation about FIGS. 12A˜12D. The user terminals 102, 103 sends data such as “Update”, “To close scene” or the like to the image forming apparatus 104 on the basis of the state information.

The following is to explain a process of Web data sent from user terminal.

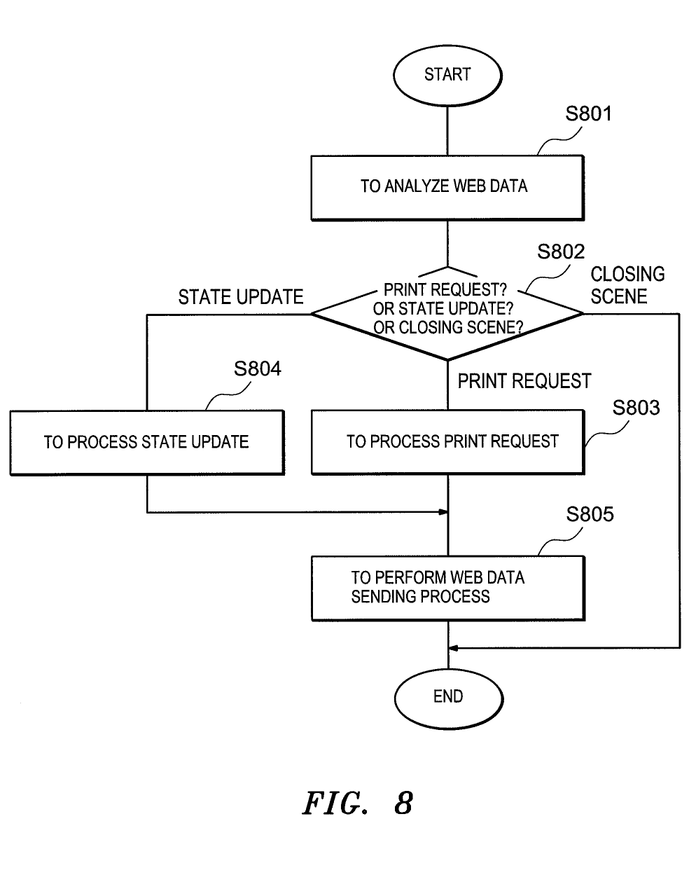

FIG. 8 is a flowchart for explaining operation about a Web data process of image forming apparatus in embodiment 1.

The following is to perform an explanation according to an order from step S801 to step S806 in the flowchart of FIG. 8, together with FIGS. 2, 3, 11 and 12.

Step S801:

The Web data processing section 311 of the image forming apparatus 104 analyzes the Web data received from the Web browser 211 of, for example, the user terminal 102.

Step S802:

The Web data processing section 311 divides processes according to request in Web data received from the user terminal 102. In the case to request print execution shown by FIG. 11, step S803 is executed; in the case to request state update shown by FIG. 12A, step S804 is executed. However, in the case to request to close scene shown in FIGS. 12A˜12D, the Web browser 211 of the user terminal 102 closes scene and ends the process.

Step S803:

The Web data processing section 311, is received a request of print execution from the user terminal 102, notifies the print data store managing section 307 of a print request.

Step S804:

The Web data processing section 311, if received a request of state update from the user terminal 102, notifies the print data store managing section 307 of a confirmation request for apparatus state.

Step S805:

The print data store managing section 307 confirms the state of the image forming apparatus 104, and supplies state information to the Web data processing section 311. The Web data processing section 311 generates Web page data representing current state and sends it to the user terminal 102. As stated above, the FIGS. 12A˜12D show an example of the state information of image forming apparatus such as “print start”, “print completion”, “print failure”, “data deletion”.

Next, it is to explain processes for store and management of print data in the image forming apparatus 104 of embodiment 1.

In the print data stored in the image forming apparatus, its store deadline is previously set, when the deadline comes, the stored print data is deleted. Thereby, memory in image forming apparatus can be used effectively. Moreover, regarding setting method of the store deadline, it may previously set in image forming apparatus; and it may set when delivery source sends print data.

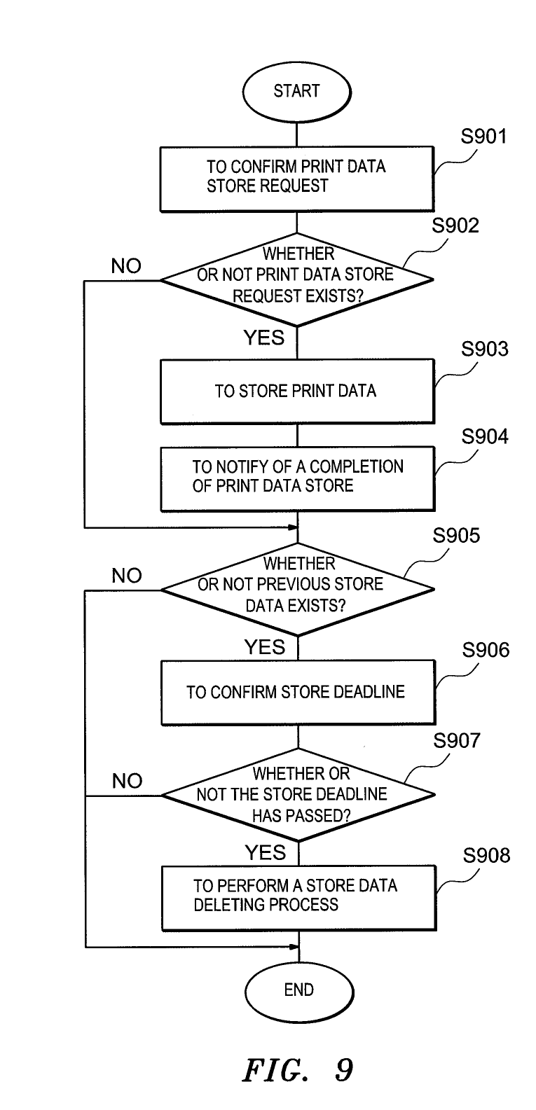

FIG. 9 is a flowchart for explaining operation to store and manage print data in image forming apparatus in embodiment 1.

The following is to perform an explanation according to an order from step S901 to step S909 in the flowchart of FIG. 9, together with FIG. 3. Moreover, in the flowchart, a transferring process to transfer print data to the other image forming apparatus 109 is omitted.

Step S901:

The data receiving section 302 of the image forming apparatus 104 receives the print data; and supplies the print data to the receiving data analyzing section 303. The receiving data analyzing section 303 analyzes whether or not the print data needs to be stored.

Step S902:

The receiving data analyzing section 303 confirms whether or not a store request is appended to the received print data. If it is appended, step S903 is executed; if it is not appended, step S905 is executed.

Step S903:

Because a store request is appended to the print data, in order to store the print data, the receiving data analyzing section 303 supplies user information and the print data to which the store request is appended, to the print data editing section 304. Further, the receiving data analyzing section 303 supplies user information to the print data store managing section 307. Later, the print data editing section 304 stores the print data into the print data storing section 309. The print data editing section 304, after the store is completed, sends a notification to notify of a completion to the print data store managing section 307.

Step S904:

The print data store managing section 307, after received a store completion notification from the print data editing section 304, refers to the use setting information (FIG. 4A) in the user information, supplies information of user terminal to deliver and information representing store location of the stored print data. Moreover, regarding the following process of the mail delivery controlling section 310, because it is the same as stated in step S707 in flowchart shown by FIG. 7, so it is omitted. Next, it is to explain the process for management of print data stored in the image forming apparatus 104 according to steps on and after step S905 in the flowchart.

Step S905:

The print data store managing section 307 confirms whether or not there is previous print data. If previous print data is stored, step S906 is executed; if previous print data is not stored, the process is ended.

Step S906:

The print data store managing section 307 confirms a store deadline of the stored print data. Here, it is to explain the store deadline. With respect to the print data stored in the print data storing section 309, a store deadline is previously set. When the store deadline comes, the print data is deleted. Moreover, regarding setting method of the store deadline, it may previously set in image forming apparatus; and it may set when delivery source sends print data to which store request is appended.

Step S907:

If it is print data whose store deadline has passed, step S908 is executed; if it is print data whose store deadline does not pass, the process is ended.

Step S908:

Because the store deadline of the print data has passed, the print data store managing section 307 deletes the print data.

Next, it is to explain a transfer process to transfer respective information to the image forming apparatus 109 from the image forming apparatus 104 of embodiment 1.

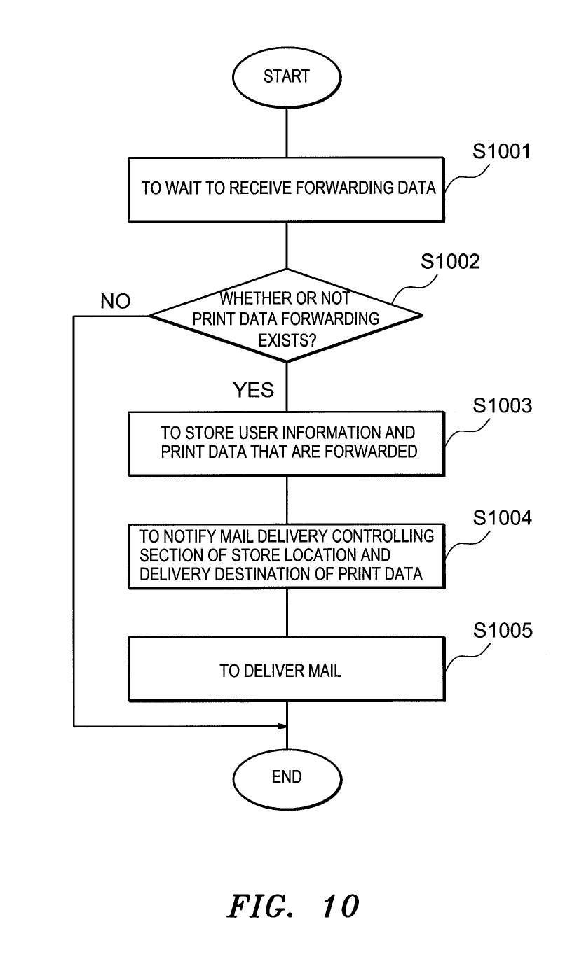

FIG. 10 is a flowchart for explaining operation about communication between image forming apparatuses in embodiment 1.

The following is to perform an explanation according to an order from step S1001 to step S1005 in the flowchart of FIG. 10, together with FIG. 3.

Step S1001:

The inter-apparatus communicating section 312 of the image forming apparatus 109 confirms whether or not user information representing user terminal and print data to which a store request is appended are transferred from the image forming apparatus 104.

Step S1002:

If user information representing user terminal serving as delivery destination and print data to which a store request is appended are transferred from the image forming apparatus 104 to the image forming apparatus 109, step S1003 is executed; if they are not, the process is ended.

Step S1003:

The inter-apparatus communicating section 312 of the image forming apparatus 109 stores the user information representing user terminals 106˜108 and the print data to which a store request is appended that are transferred from the image forming apparatus 104, into the print data storing section 309. The inter-apparatus communicating section 312 of the image forming apparatus 109 notifies the print data store managing section 307 in the image forming apparatus 109 of a store completion. Further, the inter-apparatus communicating section 312 of the image forming apparatus 109 supplies store location of the print data and the user information representing the user terminals 106˜108 to the print data store managing section 307.

Step S1004:

The print data store managing section 307 of the image forming apparatus 109, after received the notification of store completion and the information about store location of print data, supplies the information about store location of print data and the user information representing the user terminals 106˜108 to the mail delivery controlling section 310 of the image forming apparatus 109. The mail delivery controlling section 310 of the image forming apparatus 109 generates a mail which describes URL representing a print execution, from the information about store location of print data and the user information representing the user terminals 106˜108.

Step 1005:

The mail delivery controlling section 310 of the image forming apparatus 109 delivers the mail to the user terminals 106˜108 represented in the user information.

As stated above, according to the embodiment 1, in an image forming system in which user terminal and image forming apparatuses are connected via network, information indicating delivery destination and print data are stored in the image forming apparatus, and a notification is sent from the image forming apparatus to the delivery destination to notify that the print data exists and print execution is possible, thus, delivery source does not need to directly send print data to delivery destination.

Therefore, because it is unnecessary for delivery source to directly send print data to delivery destination, traffic on network or LAN in company is not increased and mail server becomes unnecessary. So it is possible to supply an image forming system whose structure become simple and which can easily print electronic file, without supplying special software.

### Embodiment 2

In the embodiment, there is a structure as well as the embodiment 1, however, in mail sent to user terminal of delivery destination from image forming apparatus, not only a URL for a print execution is stated, but also a URL for sending a print needlessness also is stated.

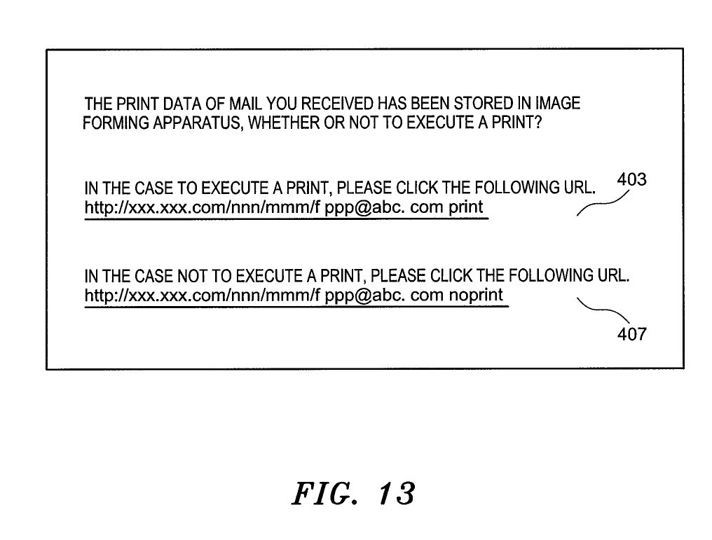

FIG. 13 is an explanatory diagram showing a mail display scene for mail delivered to user terminal form image forming apparatus in embodiment 2.

As shown by FIG. 13, in the mail display scene, a message of “whether or not to execute print?” is displayed for notifying that the image forming apparatus has stored print data; further, a URL 403 in the case to execute print and a URL 407 in the case that print is unnecessary are displayed.

Next, it is to explain a Web data process including operation of “print needlessness” in embodiment 2, through using a flowchart.

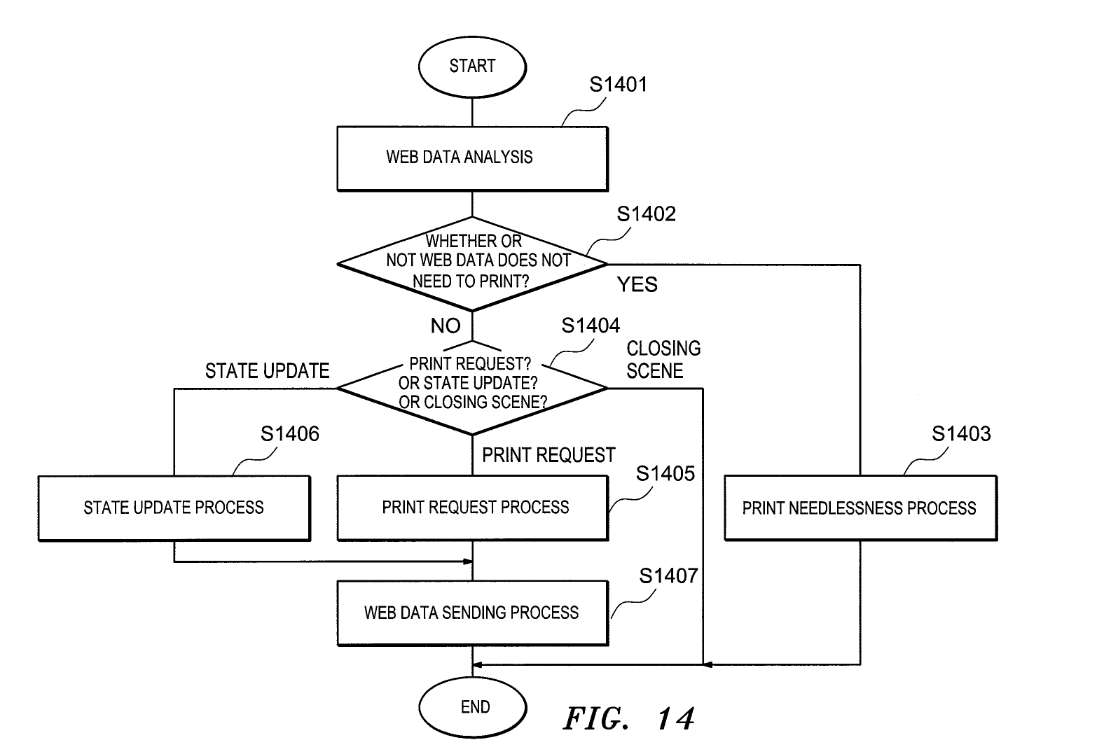

FIG. 14 is a flowchart for explaining operation about a Web data process of image forming apparatus in embodiment 2.

The following is to perform an explanation according to an order from step S1401 to step S1407 in the flowchart of FIG. 14. Moreover, step S1401, steps S1404˜1407 are the same as the step S801, steps S802˜S805 in FIG. 8 of embodiment 1, their explanations are omitted.

Step S1402:

The Web data processing section 311 of the image forming apparatus 104 analyzes the Web data received from the Web browser 211 of, for example, the user terminal 102. If a request un-needing print is received as an analysis result, step S1403 is executed; if the request is not received, step S1404 is executed.

Step S1403:

The Web data processing section 311 accepts the request of “print needlessness” received from the user terminal, and notifies the print data store managing section 307 of user name of delivery destination and the request of “print needlessness”.

Thus, in the embodiment 2, because the image forming apparatus can judges whether or not user terminal needs the stored print data, it is possible to delete the print data before the store deadline of the print data comes.

Next, it is to explain process for store and management of print data of image forming apparatus including operation of “print needlessness” of embodiment 2.

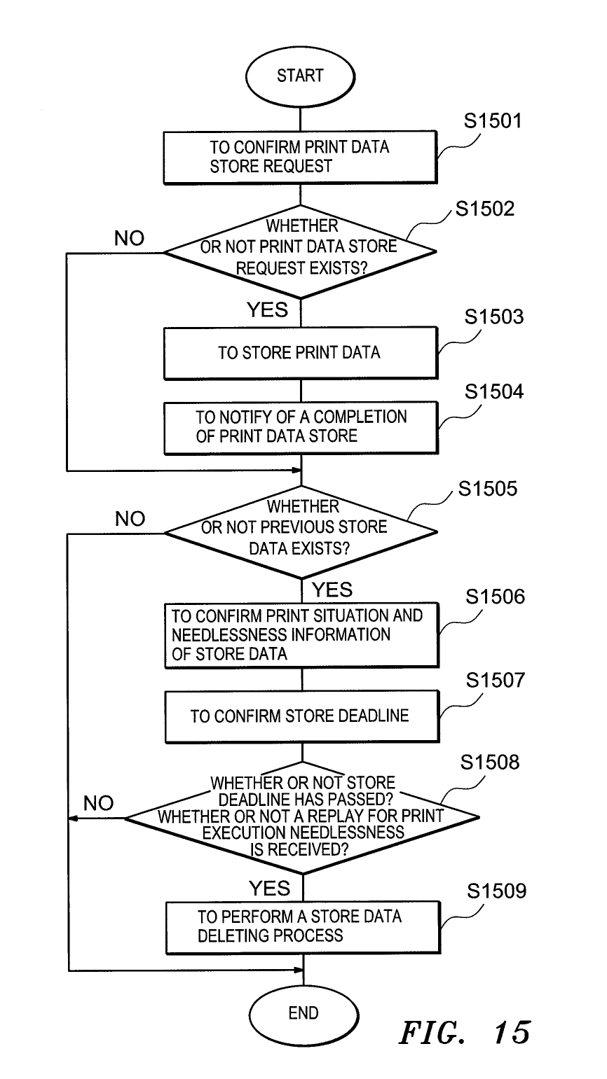

FIG. 15 is a flowchart for explaining operation to store and manage print data in image forming apparatus in embodiment 2.

The following is to perform an explanation according to an order from step S1501 to step S1509 in the flowchart of FIG. 15, together with FIG. 3. Moreover, because steps S1501˜1505 are the same as the steps S901˜905 in embodiment 1, their explanations are omitted.

Step S1506:

In the case that the print data is stored, the print data store managing section 307 confirms which of a print execution of the stored print data and a request of “print needlessness” is sent from the user terminal of the delivery destination.

Step S1507:

The print data store managing section 307 confirms whether or not the store deadline of the print data passes.

Step S1508:

In the case that the store deadline has passed and either of “print execution” and “print needlessness” is received from any user terminal of delivery destination with respect to the print data being stored, step S1509 is executed; if the store deadline does not pass and either of “print execution” and “print needlessness” is not received from any user terminal of delivery destination with respect to the print data being stored, the process is ended.

Step S1509:

In the case that the store deadline has passed and either of “print execution” and “print needlessness” is received from any user terminal of delivery destination, the print data store managing section 307 deletes the corresponding print data.

As stated above, according to the embodiment 2, in the mail sent to the user terminal from the image forming apparatus, not only a URL for print execution is described, but also a URL for print needlessness is described. Therefore, it is possible to obtain such effect as embodiment 1; further, because the print data stored in the image forming apparatus can be deleted at an early stage, it is possible to effectively use memory of the image forming apparatus.

### Embodiment 3

In the embodiment, there is a structure as well as the embodiment 1, but there are the following differences. That is, the operation is the same as embodiments 1 and 2 that the image forming apparatus 104, after received the user information representing user terminals 102˜103, 106˜108 and print data to which a store request is appended, from the user terminal 101 of delivery source, stores the print data. However, in the embodiment 3, operations are different from the embodiments 1 and 2 that the image forming apparatus 104 verifies user information; in the case that the use setting person of the other image forming apparatus 109 exists, delivers mail before transferring print data and the like. That is, the image forming apparatus 104 delivers mail describing URL representing a print instruction, not only to user terminals 102 and 103, but also to user terminals 106˜108 having received the mail. Then, at that time when a reply of print execution is sent to the image forming apparatus 104 from any of user terminals 106˜108, the image forming apparatus 104 performs a transfer process to transfer print data and the like to the image forming apparatus 109. In the case, the image forming apparatus 104, transfers user information representing user terminals 106˜108 and print data to which a store request is appended; further transfers a request of print execution. Therefore, the image forming apparatus 109 stores the respective data and starts a print process.

Moreover, in the embodiment 3, the print data store managing section 307 manages transfer existence/inexistence information of print data except the store deadline of print data being stored; when first received a print request from user terminal of other apparatus, registers a transfer completion flag into management information; when second received a print request from user terminal of other apparatus, because it is possible to confirm that the print data is previously sent through referring to the management information, so only sends the information representing store location of print data and print request without sending the print data.

Next, it is to explain operations till the user terminals 102˜103 and 106˜108 execute a print of print data belonging to the user terminal 101 shown by FIG. 1.

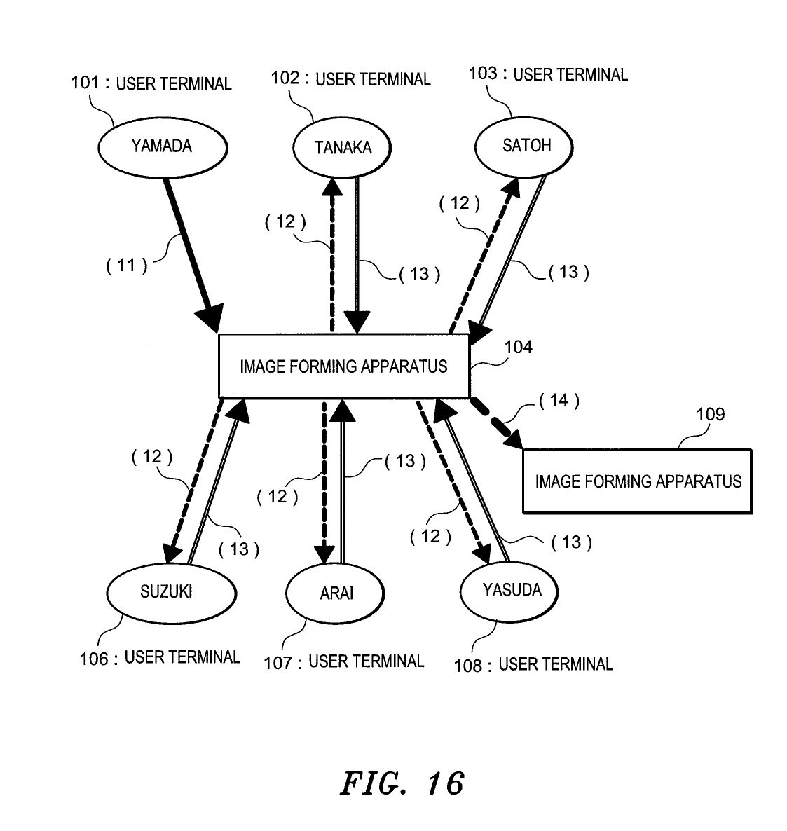

FIG. 16 is an explanatory diagram about flows of respective information between apparatuses in embodiment 3.

The respective information includes print data, store request, user information, print request and the like. The following is to explain flows of the respective information.

Flow (11) of information:

The user terminal 101 (delivery source) regards the user terminals 102˜103 and 106˜108 as delivery destination to send user information and print data in which store request is appended to the image forming apparatus 104.

Flow (12) of information:

The image forming apparatus 104, after stored the print data, delivers a mail describing a store location of print data being stored and a URL for executing print to all of the user terminals 102˜103 and 106˜108.

Flow (13) of information:

The user terminals 102˜103 and 106˜108 drive Web browser 211 according to the received mail to send an instruction of print execution and the like to the image forming apparatus 104. The image forming apparatus 104 refers to the use setting information shown by FIG. 4A to confirm user terminal having sent the instruction of print execution and the like; if the user terminals 102˜103 are confirmed, immediately performs a process of print execution and the like.

If the image forming apparatus 104 confirmed receiving the instruction of print execution and the like from user terminals 106˜108, the image forming apparatus 104 performs operation such as flow (14) of information.

Flow (14) of information:

The image forming apparatus 104, in the case to receive the instruction of print execution and the like from the user terminals 106˜108, transfers user information representing user terminals 106˜108, print data to which a store request is appended, and the request of print execution, to the image forming apparatus 109. The image forming apparatus 109, after received the respective data, stores these data and performs a process of print execution and the like, further sends information representing the store location of print data to the image forming apparatus 104.

Next, it is to explain such case to send instruction of print request from any of the user terminals 102˜103 and 106˜108 through using a flowchart.

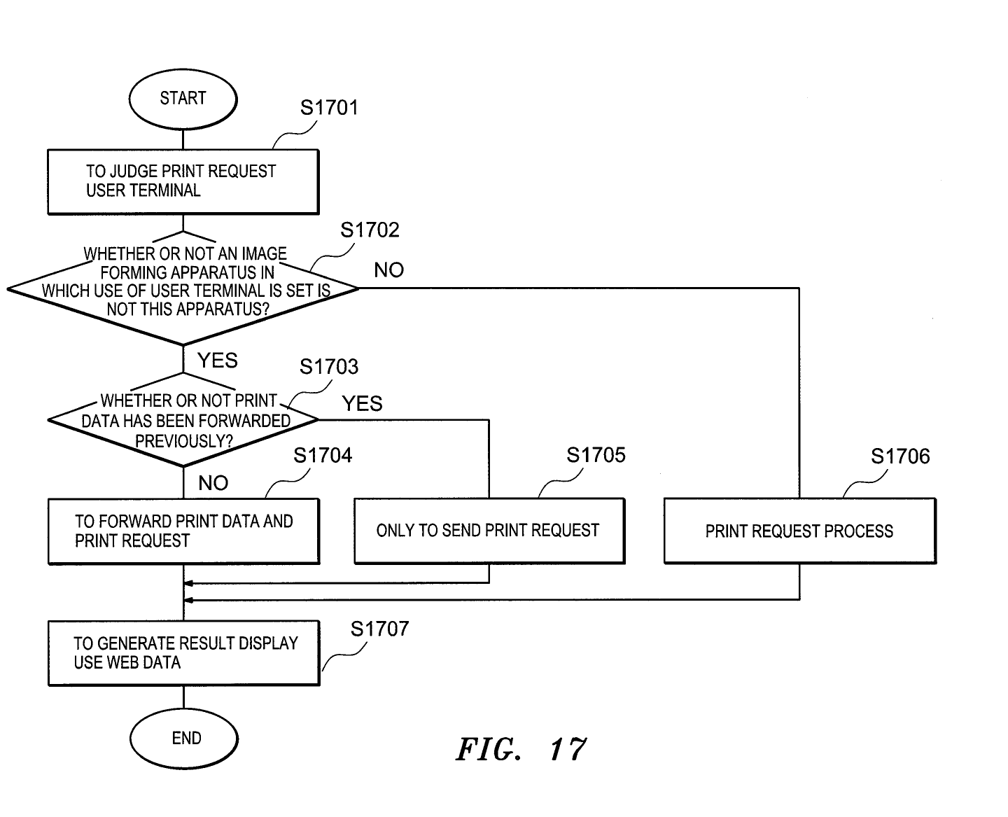

FIG. 17 is a flowchart for explaining operation about a process of print request outputted form user terminal in embodiment 3.

The following is to perform an explanation according to an order from step S1701 to step S1707 in the flowchart of FIG. 17, together with FIGS. 3, 4, 16.

Step S1701:

After the image forming apparatus 104 received an instruction of print request from any of the user terminals 102˜103 and 106˜108, the Web data processing section 311 of the image forming apparatus 104 supplies information representing user terminal and the instruction of print request to the print data store managing section 307. The print data store managing section 307 reads out use setting information 401 from the information memorizing section 306 in order to judge user terminal having sent the print request is set to use which of image forming apparatuses.

Step S1702:

The print data store managing section 307 judges user terminal having sent the print request is set to use which of the image forming apparatus 104 and the image forming apparatus 109 on the basis of the use setting information 401 shown By FIG. 4A. In the case that the user terminal which sent the instruction of print request to the image forming apparatus 104 is the user terminal 102 or the user terminal 103, step S1706 is executed; in the case that the user terminal which sent the instruction of print request to the image forming apparatus 104 is the user terminal 106, the user terminal 107 or the user terminal 108, step S1703 is executed.

Step S1703:

Because the user terminal which sent the instruction of print request to the image forming apparatus 104 is the user terminal 106, the user terminal 107 or the user terminal 108, the image forming apparatus 109 which is set to be used by the user terminals 106˜108 needs to perform a print. The print data store managing section 307 manages store deadline and transfer existence/inexistence information of print data being stored. The print data store managing section 307, when received the print request outputted from delivery destination, uses management information to confirm whether or not to transfer the print data to the image forming apparatus 109.

If the print data is never transferred to the image forming apparatus 109, step S1704 is executed; if the print data has been transferred to the image forming apparatus 109, step S1705 is executed.

Step S1704:

Because the print data is never transferred to the image forming apparatus 109, the print data store managing section 307 transfers the user information representing the user terminals 106˜108, the print data to which a store request is appended, and the request of print execution to the image forming apparatus 109. The image forming apparatus 109 stores respective data and starts a print.

Step S1705:

Because the print data has been previously transferred to the image forming apparatus 109, the print data store managing section 307 of the image forming apparatus 104 sends information representing store location received from the image forming apparatus 109 about the print data, and the print request to the image forming apparatus 109. Then, the store data print processing section 308 of the image forming apparatus 109 starts a print.

Step S1706:

Because the user terminal which sent the instruction of print request to the image forming apparatus 104 is the user terminal 102, or the user terminal 103, the store data print processing section 308 of the image forming apparatus 104 starts to print the print data that is previously stored and is requested to print.

Step S1707:

In order to report a result of print process to user terminal, the Web data processing section 311 generates Web data and sends it to user terminal.

Next, it is to explain mail delivery of the image forming apparatus 104 in embodiment 3.

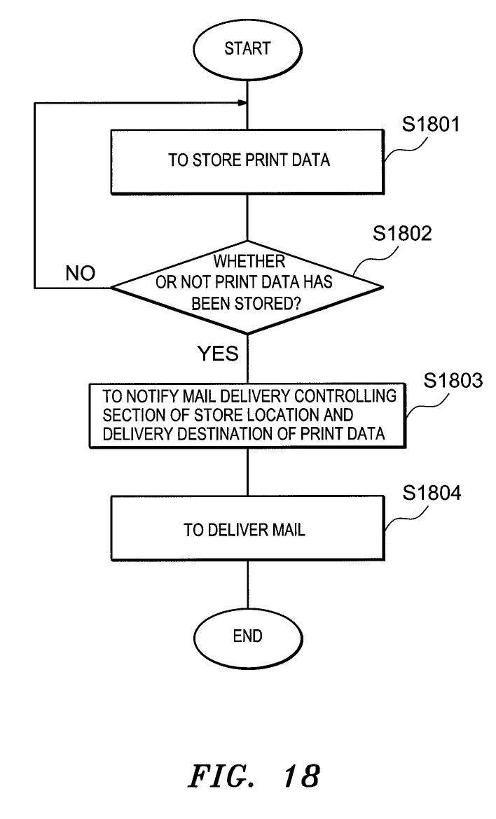

FIG. 18 is a flowchart for explaining operation about mail delivery of image forming apparatus in embodiment 3.

The following is to perform an explanation according to an order from step S1801 to step S1804 in the flowchart of FIG. 18, together with FIG. 3.

Step S1801:

After the image forming apparatus 104 received the user information representing the user terminals 102˜103 and 106˜108 serving as delivery destinations and print data to which a store request is appended from the user terminal 101 serving as delivery source, the print data editing section 304 of the image forming apparatus 104 stores the respective data into the print data storing section 309. The print data editing section 304, after data is stored, sends a notification representing a store completion to the print data store managing section 307.

Step S1802:

The print data store managing section 307 waits for a notification representing a store completion of print data. When the notification is received, step S1803 is executed; if there is no the notification, step S1801 is executed for waiting for the notification once more.

Step S1803:

The print data store managing section 307, after received the notification of store completion of print data, supplies user information of delivery destination and information of store location of print data to the mail delivery controlling section 310. The mail delivery controlling section 310 generates mail describing the store location of print data stored in the image forming apparatus 104 and a URL representing a print execution.

Step S1804:

The mail delivery controlling section 310 delivers the generated mail to the user terminals 102˜103 and 106˜108 serving as delivery destinations.

Next, it is to explain operations of receiving confirmation for user information representing user terminals of 106˜108 serving as delivery destinations, print data to which a store request is appended, and request of print execution, in the image forming apparatus 109.

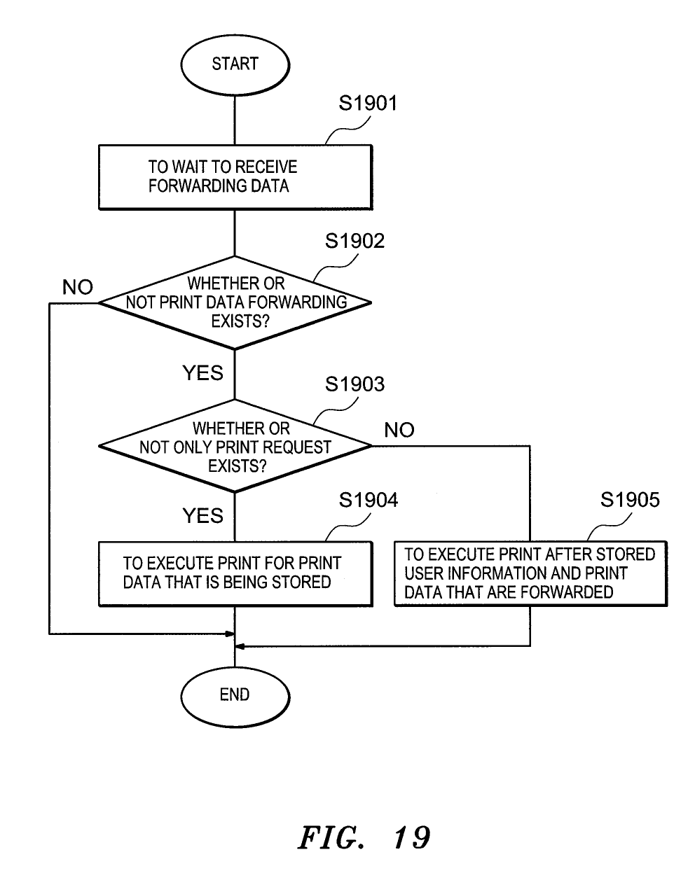

FIG. 19 is a flowchart for explaining operation about communication between image forming apparatuses in embodiment 3.

The following is to perform an explanation according to an order from step S191 to step S1905 in the flowchart of FIG. 19.

Step S1901:

The inter-apparatus communicating section 312 of the image forming apparatus 109 waits to receive data of image forming apparatus 104.

Step S1902:

When data is transferred from the image forming apparatus 104, step S1903 is executed; if data is not transferred from the image forming apparatus 104, the process is ended.

Step S1903:

The inter-apparatus communicating section 312 analyzes the data transferred from the image forming apparatus 104. In the case that the transferred data only contains information representing store location of print data and a print request, because it represents that print data has been previously transferred, step S1904 is executed; in the case that user information representing user terminals 106˜108, print data to which a store request is appended, and a print request are transferred, step S1905 is executed.

Step S1904:

The inter-apparatus communicating section 312 of the image forming apparatus 109 notifies the print data store managing section 307 that the information representing store location of print data and print request have been received. The print data store managing section 307 obtains the print data from the print data storing section 309 on the basis of the information representing store location of print data; and supplies the print data to the store data print processing section 308.

Then, the store data print processing section 308 starts to print.

Step S1905:

The inter-apparatus communicating section 312 of the image forming apparatus 109 stores the user information representing user terminals 106˜108 and print data to which a store request is appended, that are transferred from the image forming apparatus 104, into the print data storing section 309. After they are stored, the inter-apparatus communicating section 312 notifies the print data store managing section 307 of the store location of print data and the user information representing user terminals 106˜108. Later, the store data print processing section 308 starts to print the stored print data.

As stated above, in the embodiment 3, the transfer of the print data between the image forming apparatuses is not performed until the print request comes. Thereby, as well as the embodiment 2, it is possible to effectively use the memory of image forming apparatus.

### Embodiment 4

In the embodiments 1˜3, the mail enabling print and the like to be executed is sent to the user terminal of delivery destination. In the embodiment 4, the user terminal of delivery source directly sends a mail enabling print and the like to be executed to user terminal of delivery destination. In order to realize such objective, user terminal of the embodiment 4 is formed to have the following structure.

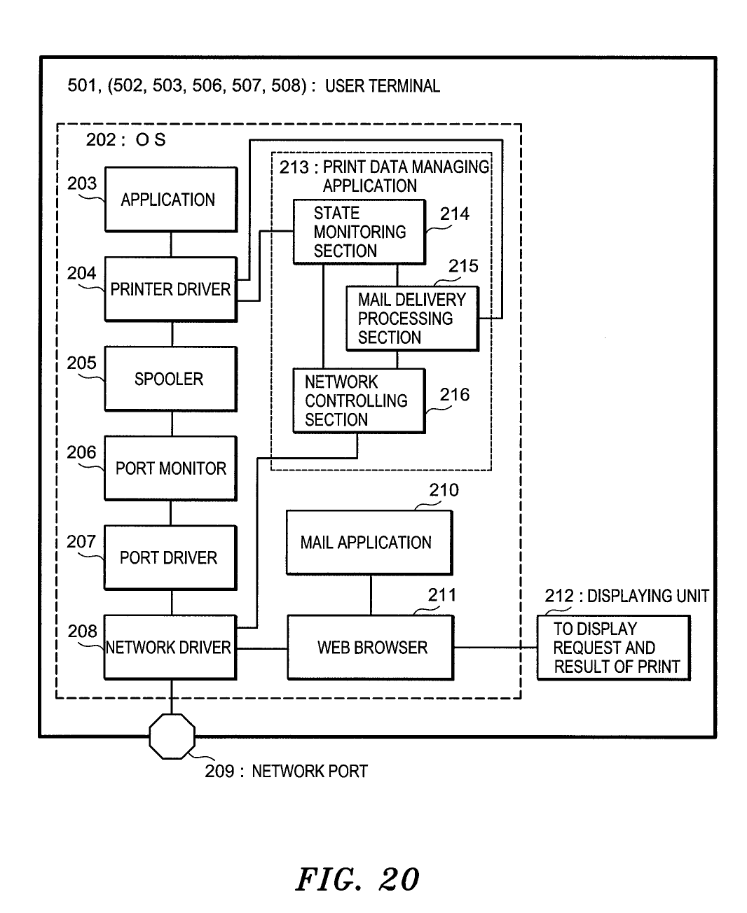

FIG. 20 is a diagram showing a structure of a user terminal in embodiment 4 of the present invention.

As shown by FIG. 20, a user terminal 501 has a displaying unit 212 and a network port 209 that serve as hardware; and various application drivers that operate on OS and serve as software. The following is only to explain components that are different from the embodiment 1, regarding the same components as the embodiment 1, the same symbols are assigned to them and their explanations are omitted.

As shown by the drawing, in the OS 202 of embodiment 1, a print data managing application 213 is added.

The print data managing application 213 is an application operating in the OS 202, also is an application to monitor store situation of print data stored in image forming apparatus. The print data managing application 213 is composed of a state monitoring section 214, a mail delivery processing section 215, and a network controlling section 216.

The state monitoring section 214 is a part to monitors whether or not image forming apparatus has completed to store print data. The state monitoring section 214 sends a notification request of store situation of print data to image forming apparatus via the network controlling section 216. The image forming apparatus which has received the notification request, after the print data is stored, sends a notification representing that store of print data is completed and sends information representing store location of print data to the state monitoring section 214 of user terminal of delivery source. The state monitoring section 214 receives the notification of store completion and supplies the information representing store location to the mail delivery processing section 215.

The mail delivery processing section 215 uses the information representing store location, supplied from the state monitoring section 214, to generate mail which describes a URL representing a print instruction; and delivers the mail to user terminal of delivery destination via the network controlling section 216.

Continuously, it is to explain an image forming apparatus 504 of embodiment 4.

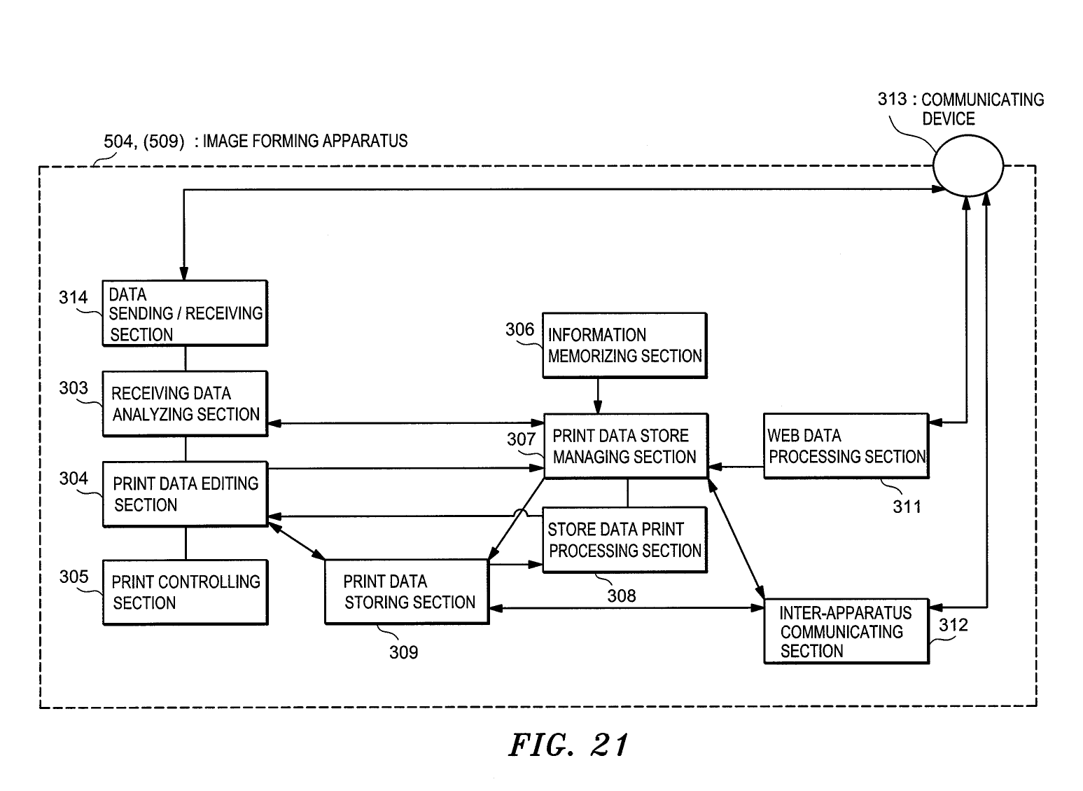

FIG. 21 is an explanatory diagram showing a structure of an image forming system of the present invention in embodiment 4.

As shown by FIG. 21, an image forming apparatus 504 of embodiment 4, is formed by deleting the mail delivery controlling section 310 from the image forming apparatus 104 of embodiment 1. Further, instead of the data receiving section 302, a data sending/receiving section 314 is furnished. The data sending/receiving section 314 notifies the user terminal of delivery source of store completion of print data.

According to such structure, in the embodiment 4, the following operations are performed. That is, the print data editing section 304 of the image forming apparatus 504, after received user information representing user terminals 502˜503 and 506˜508 serving as delivery destinations and print data to which a store request is appended, stores the print data into the print data storing section 309. The print data store managing section 307, after received a store completion of the print data editing section 304, receives and keeps the print data generated by the print data editing section 304, and the information representing store location of user information in the print data storing section 309.

Further, the print data store managing section 307 verifies the user information representing user terminals 502˜503 and 506˜508 serving as delivery destinations. The print data store managing section 307, when detected the user terminals 502˜503 to use other image forming apparatus 509 by referring to the use setting information shown by FIG. 4A and the IP address shown by FIG. 4B, transfers the user information and the print data to which store request is appended, to the image forming apparatus 509 via the inter-apparatus communicating section 312.

The image forming apparatus 509, after the transferred print data to which store request is appended is stored, sends information representing a store location of the print data to the image forming apparatus 504 via the inter-apparatus communicating section 312. After the print data store managing section 307 of the image forming apparatus 504 completed to store and transfer the print data to which store request is appended, the data sending/receiving section 314 sends a notification of store completion, information representing store location of print data for the user terminals 502˜503, and information representing store location of print data for the user terminals 506˜508, to the user terminal 501.

The user terminal 501 delivers a mail which describes the store location of print data and a URL representing a print instruction to the user terminals 502˜503 and 506˜508 of delivery destinations. The image forming apparatus 504 and the image forming apparatus 509 perform print after received request of print execution from the user terminal of delivery destination.

Continuously, it is to explain operations that the user terminals 502˜503 and 506˜508 request a print of print data belonging to the user terminal 501.

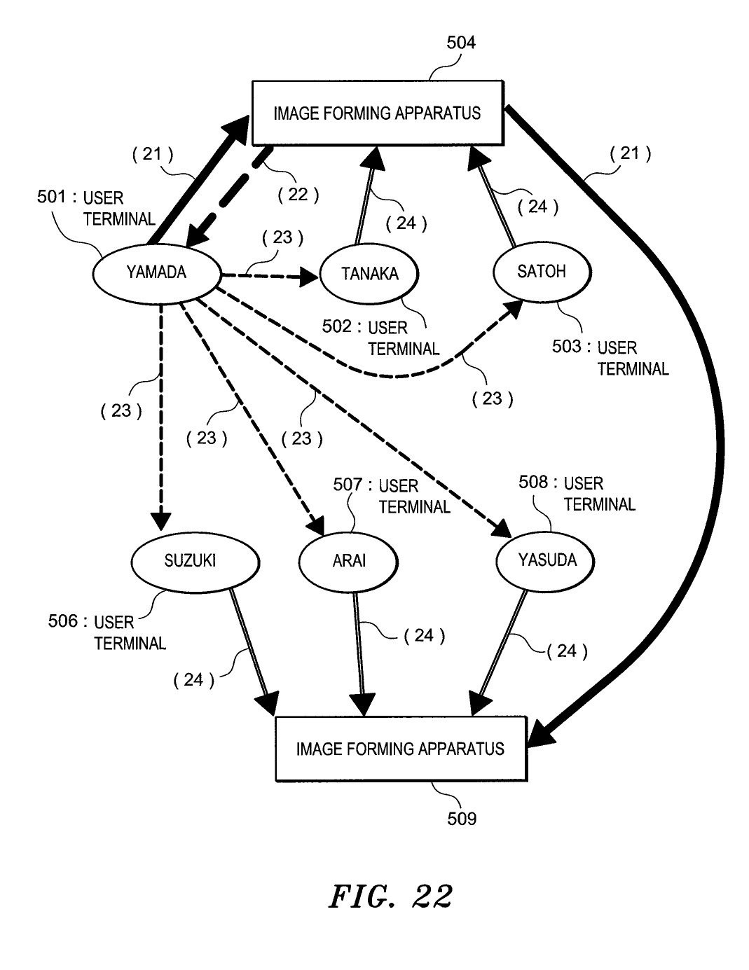

FIG. 22 is an explanatory diagram about flows of respective information between apparatuses in embodiment 4.

The respective information includes print data, store request, user information, print request and the like. As shown by FIG. 22, two image forming apparatuses 504, 509 and six user terminals 501˜503, 506˜508 are connected via network. The following is to explain flows of the respective information.

Flow (21) of information:

The user terminal 501 (delivery source) sends user information representing user terminals 502˜503 and 506˜508 serving as delivery destination and print data to which a store request is appended, to the image forming apparatus 504.

The image forming apparatus 504 detects that the user terminals 506˜508 that are set to use the image forming apparatus 509 are delivery destinations from the user information representing user terminals 502˜503 and 506˜508 through referring to the use setting information shown by FIG. 4A and the IP address shown by FIG. 4B; then transfers the print data to which store request is appended, to the image forming apparatus 509.

Flow (22) of information:

The image forming apparatus 504 stores the print data to which store request is appended; and after stored the print data, generates information store location of the print data. Further, the image forming apparatus 509 also stores the print data to which store request is appended; and after stored the print data, sends information representing store location of the print data to the image forming apparatus 504 via the inter-apparatus communicating section 312. The image forming apparatus 504, when received the information representing store location of the print data for respective user terminals, sends a notification representing store completion and the information representing store location of the print data being stored, to the user terminal 501.

Flow (23) of information:

The user terminal 501, after received the information representing store location of the stored print data from the image forming apparatus 504, delivers a mail describing a store location of print data being stored and a URL for executing print to all of the user terminals 502˜503 and 506˜508 of delivery destinations.

Flow (24) of information:

The user terminals 502˜503 and 506˜508 respectively drive Web browser 211. The user terminals 502˜503 respectively send an instruction of print execution to the image forming apparatus 504. The user terminals 506˜508 respectively send an instruction of print execution to the image forming apparatus 509. The respective image forming apparatuses start to print according to the instruction of user terminal.

Next, it is to explain operation of user terminal 501 of embodiment 4

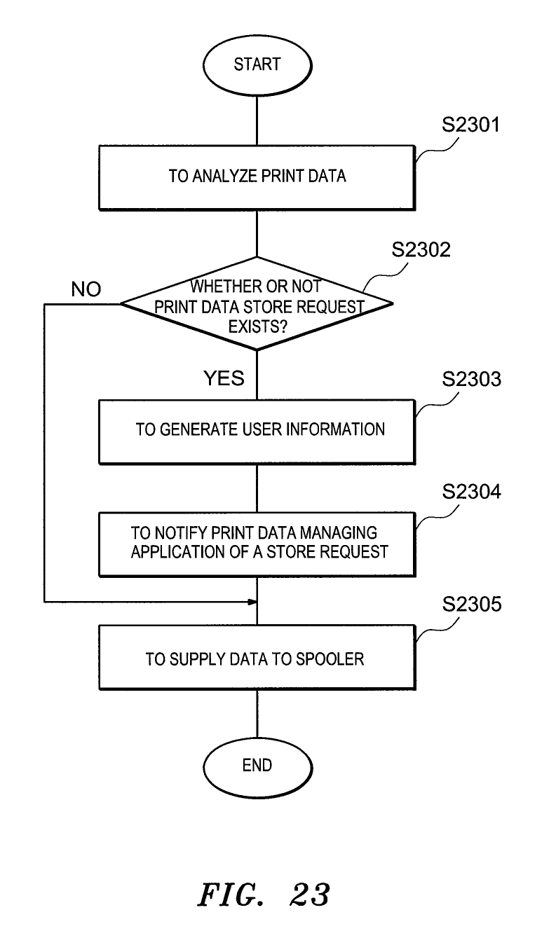

FIG. 23 is a flowchart for explaining operation of printer driver of user terminal in embodiment 4.

The following is to perform an explanation according to an order from step S2301 to step S2305 in the flowchart of FIG. 23, together with FIG. 20.

Step S2301:

The printer driver 204 analyzes print data generated by application 203.

Step S2302:

The printer driver 204 judges whether or not a store request is appended to the print data. If a store request is appended to the print data, step S2303 is executed; if a store request is not appended to the print data, step S2305 is executed.

Step S2303:

The printer driver 204 generates user information representing the user terminals 502˜503 and 506˜508, through user of delivery source inputs instruction for users of delivery destination Step S2304:

The printer driver 204 notifies the state monitoring section 214 that the user information representing user terminals 502˜503 and 506˜508 serving as delivery destinations and print data to which a store request is appended, are generated. Further, the printer driver 204 notifies the mail delivery processing section 215 of the user terminals 502˜503 and 506˜508 of delivery destinations.

Step S2305:

In the case that a store request is not appended to the print data, the printer driver 204 changes the print data into printable print data and sends it to the spooler 205. In the case that a store request is appended to the print data, the printer driver 204 first supplies the store request and the generated user information to the spooler 205, second changes the print data into printable print data and sends it to the spooler 205.

Next, it is to explain operation of print data management application of user terminal 501 in embodiment 4.

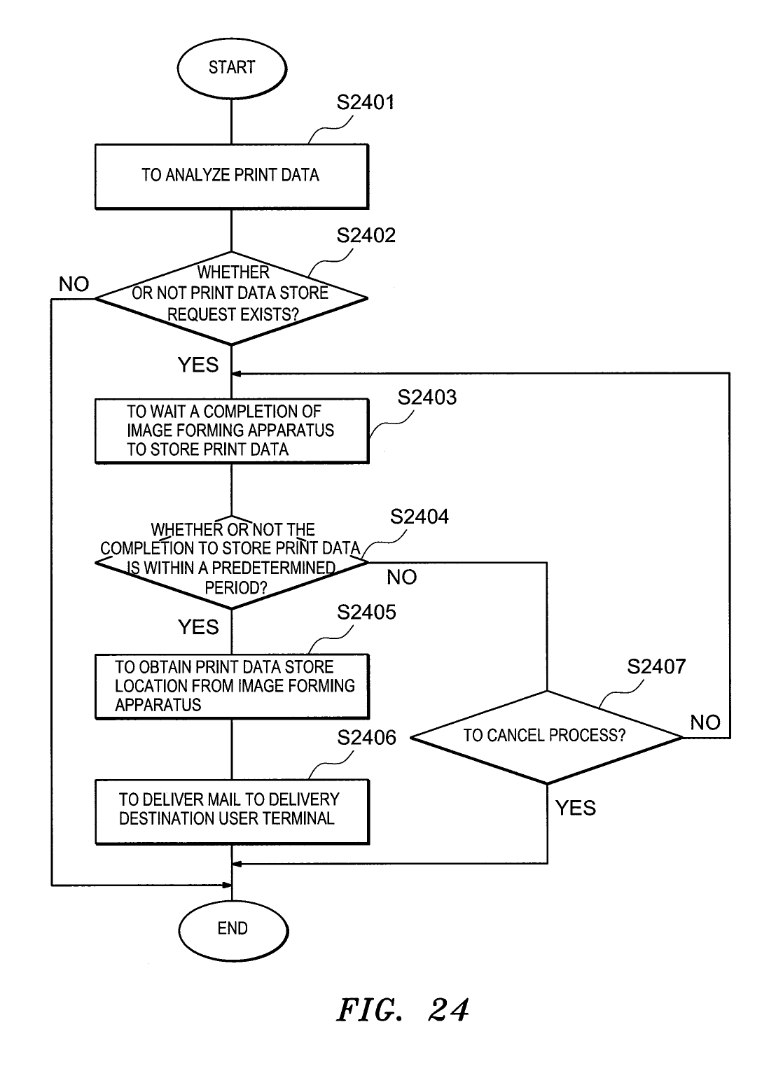

FIG. 24 is a flowchart for explaining operation about print data management application of user terminal in embodiment 4.

The following is to perform an explanation according to an order from step S2401 to step S2407 in the flowchart of FIG. 24, together with FIG. 20.

Step S2401:

The printer driver 204 analyzes print data generated by application 203. Further, the printer driver 204 judges whether or not a store request is appended to the print data.

Step S2402:

The state monitoring section 214 receives a notification representing whether or not a store request is appended to the print data from the printer driver 204. If a store request is appended to the print data, step S2403 is executed; if a store request is not appended to the print data, the process is ended.

Step S2403:

In the case that a store request is appended to the print data, the state monitoring section 214 sends a notification request of store situation to the image forming apparatus 504 via the network controlling section 216, and waits to receive a notification of store completion of print data from the image forming apparatus 504.

Step S2404:

When store of the print data is completed, step S2405 is executed; when store of the print data is not completed even if a predetermined time passed, step S2407 is executed.

Step S2405:

The state monitoring section 214, after received a notification representing the store of the print data is completed and received the information representing store location of the print data stored to correspond to delivery destination from the image forming apparatus 504, supplies these data to the mail delivery processing section 215.

Step S2406:

The mail delivery processing section 215 which has received the information representing store location of the print data stored to correspond to delivery destination, from the state monitoring section 214, generates a mail which describes a URL enabling print data stored in the image forming apparatus to be printed, on the basis of the information; and delivers the mail to the user terminals 502˜503 and 506˜508 serving as delivery destinations.

Step S2407:

When the notification representing a store completion is not received from the image forming apparatus 504 even if a predetermined time has passed, the state monitoring section 214 stops to monitor by turning off power source.

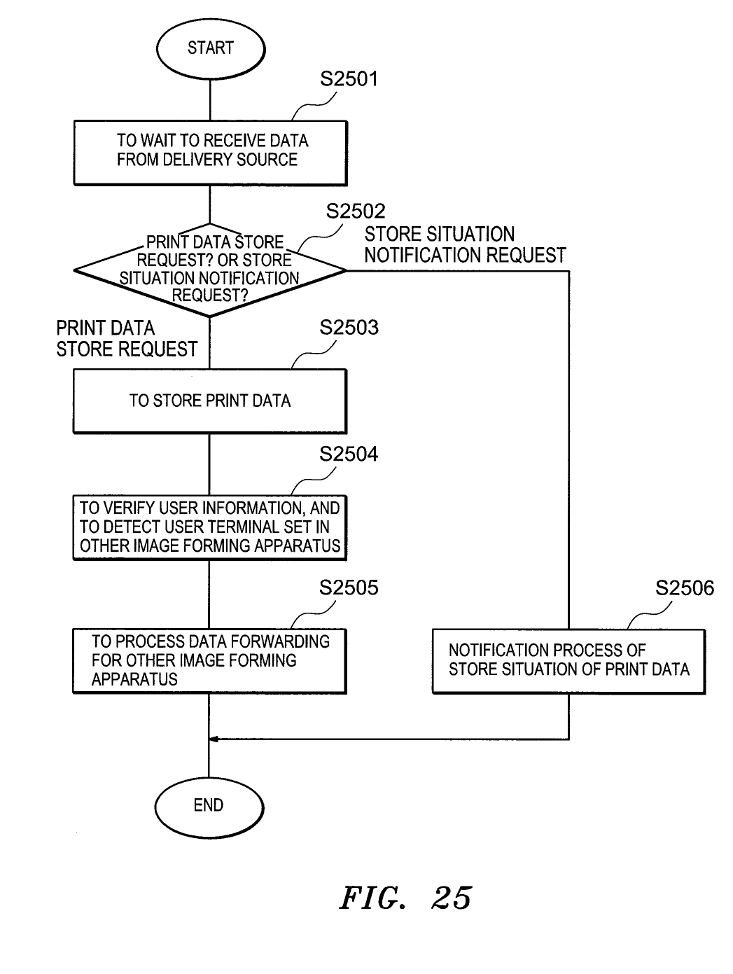

FIG. 25 is a flowchart for explaining operation about a receiving data process received from delivery source in embodiment 4.

The following is to perform an explanation according to an order from step S2501 to step S2506 in the flowchart of FIG. 25 together with FIG. 21. Moreover, here is to explain such cause that receiving data (i.e. received data) is user information representing user terminals 502˜503 and 506˜508 serving as delivery destinations and print data to which a store request is appended; or the receiving data is a notification request of store situation sent by the user terminal 501 of delivery source in embodiment 4 to the image forming apparatus 504.

Step S2501:

The data sending/receiving section 314 of the image forming apparatus 504, after received data from the user terminal 501 of delivery source, supplies the data to the receiving data analyzing section 303 for analyzing.

Step S2502:

The receiving data analyzing section 303 judges whether the received data, as receiving data, is user information representing delivery destinations and print data to which a store request is appended; or is a notification request of store situation; if it is user information and print data, step S2503 is executed; if it is notification request of store situation from the user terminal 501, step S2507 is executed.

Step S2503:

Because the receiving data is user information representing delivery destinations and print data to which a store request is appended, the receiving data analyzing section 303 supplies the data to the print data editing section 304. Further, the receiving data analyzing section 303 supplies the user information to the print data store managing section 307. The print data editing section 304 stores the data into the print data storing section 309. The print data editing section 304, after stored the data, notifies the print data store managing section 307 that the store of data is completed.

Step S2504:

The print data store managing section 307 detects whether or not use setting person except the image forming apparatus 504 exists from the user information according to the use setting information shown by FIG. 4A in the information memorizing section 306.

Step S2505:

Because the print data store managing section 307 refers to the use setting information of the information memorizing section 306 to judge that the user terminals 506˜508 that are not set to use the image forming apparatus 504 exist in the user information, the print data store managing section 307 transfers the user information of delivery destination and the print data to the image forming apparatus 509 which is set to be used by the user terminals 506˜508 via the inter-apparatus communicating section 312 through referring to the IP address of image forming apparatus in the information memorizing section 306.

Step S2506:

Further, in the case that the receiving data is notification request of store situation, the receiving data analyzing section 303 confirms a store situation with respect to the print data store managing section 307. The print data store managing section 307 supplies information representing whether the print data is in the middle of storing or has been stored to the receiving data analyzing section 303. The receiving data analyzing section 303 supplies the information to the data sending/receiving section 314 and sends it to user terminal.

As stated above, not only the embodiment 4 has the same effect as the embodiment 1, but also the embodiment does not need a mail delivery controlling section to deliver mail to image forming apparatus. Therefore, it is possible to realize a simple structure for image forming apparatus.

### Embodiment 5

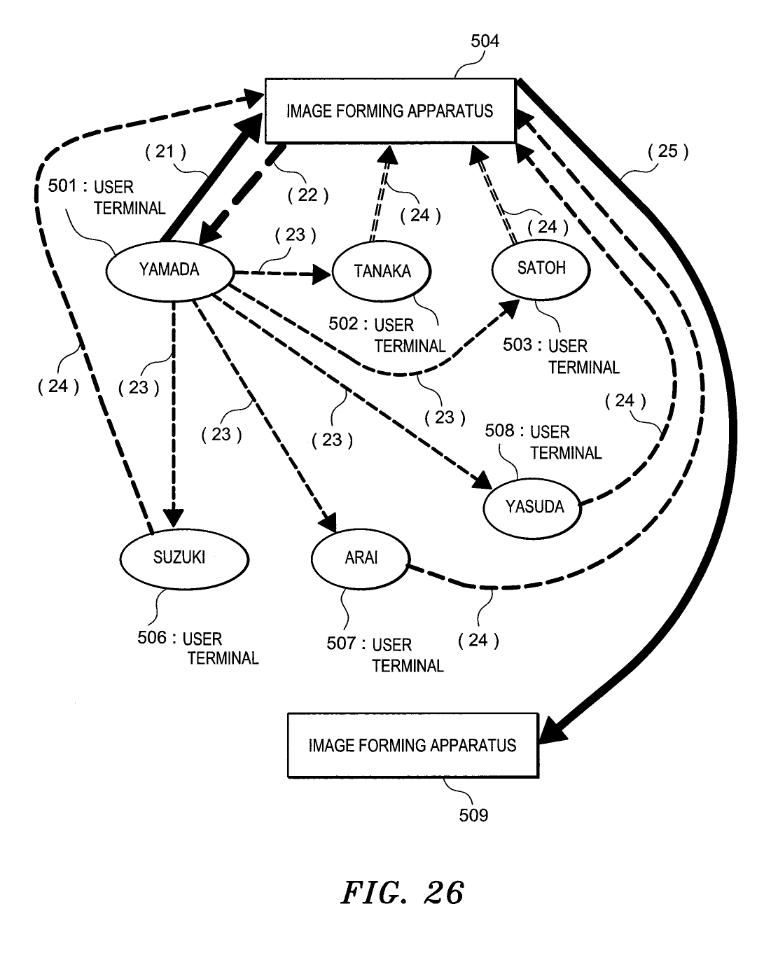

FIG. 26 is an explanatory diagram about flows of respective information between apparatuses in embodiment 5.

As shown by FIG. 26, in the embodiment 5, the user terminals 502˜503 and 506˜508 serving as delivery destinations send print request to the image forming apparatus 504; in the case that user terminal which has sent print request is one of the user terminals 506˜508, the image forming apparatus 504 transfers the print data to which store request is appended and the print request to the image forming apparatus 509; and the image forming apparatus 509, after received the print data to which store request is appended and the print request, starts a print.

As stated above, in the embodiment 5, as well as the embodiment 4, it is unnecessary to furnish a mail delivery controlling section to deliver mail in image forming apparatus; and the image forming apparatus can realize a simple structure, it is possible to obtain a simple system structure. Further, in the embodiment 5, as well as the embodiment 3, the transfer of print data between image forming apparatuses is not performed until a print request comes. Thus, because the print data is not sent to image forming apparatus which does not execute print, so it is possible to effectively use memory of image forming apparatus.

The present invention is not limited to the foregoing embodiments but many modifications and variations are possible within the spirit and scope of the appended claims of the invention.

What is claimed is:

1. An image forming apparatus which is connected with a delivery source user terminal serving as a delivery source of print data, and with at least one delivery destination user terminal allowed to use the print data via network, comprising:
a store controlling section that receives the print data to which user information representing the delivery destination user terminal is appended from the delivery source user terminal, and stores the print data into a print data storing section;
a delivery destination notifying section that performs a notification representing a print need/needlessness based on an existence of the print data and the print data, via the network, with respect to the delivery destination user terminal represented in the user information; and
a print need/needlessness judging section that, when received a print request from the delivery destination user terminal via the network, obtains the print data from the print data storing section and supplies the print data to a print processing section for executing a print of the print data.

2. The image forming apparatus according to claim 1, further comprising:
a storing section that stores use setting information representing user terminal which is set to use other image forming apparatus;
a terminal judging section that refers to the use setting information to judge whether or not the delivery destination user terminal represented in the user information corresponds to the user terminal represented in the use setting information; and
a sending control section that sends the print data to which the user information is appended to the other image forming apparatus in the case that the delivery destination user terminal is judged to correspond to the user terminal.

3. The image forming apparatus according to claim 2,
wherein the sending control section sends the print data to which the user information is appended to the other image forming apparatus when a print request is received from the user terminal.

4. An image forming system in which image forming apparatus, a delivery source user terminal serving as a delivery source of print data, and at least one delivery destination user terminal allowed to use the print data are connected via network,
wherein the delivery source user terminal has a delivery destination notifying section that performs a notification representing that the print data exists in the image forming apparatus and print request is possible, via the network, with respect to the delivery destination user terminal, and
wherein the image forming apparatus includes:
a store controlling section that receives the print data to which user information representing the delivery destination user terminal is appended from the delivery source user terminal, and stores the print data into a print data storing section; and
a print need/needlessness judging section that, when received a print request from the delivery destination user terminal via the network, obtains the print data from the print data storing section and supplies the print data to a print processing section for executing a print of the print data.

5. The image forming system according to claim 4,
wherein the image forming apparatus further includes:
a storing section that stores use setting information representing user terminal which is set to use other image forming apparatus;
a terminal judging section that refers to the use setting information to judge whether or not the delivery destination user terminal represented in the user information corresponds to the user terminal represented in the use setting information; and
a sending control section that sends the print data to which the user information is appended to the other image forming apparatus in the case that the delivery destination user terminal is judged to correspond to the user terminal.

6. The image forming system according to claim 5,
wherein the sending control section sends the print data to which the user information is appended to the other image forming apparatus when a print request is received from the user terminal.
